(19) United States
(12) Patent Application Publication
(10) Pub. No.: US 2019/0111756 A1
(43) Pub. Date: Apr. 18, 2019

(54) REFRIGERATION CYCLE DEVICE

(71) Applicant: DENSO CORPORATION, Kariya-city (JP)

(72) Inventors: Naoya MAKIMOTO, Kariya-city (JP); Mikiharu KUWAHARA, Kariya-city (JP)

(21) Appl. No.: 16/218,893

(22) Filed: Dec. 13, 2018

Related U.S. Application Data
(63) Continuation of application No. PCT/JP2017/015188, filed on Apr. 13, 2017.

(30) Foreign Application Priority Data
Jun. 16, 2016 (JP) 2016-119986

(51) Int. Cl. B60H 1/00; B60H 1/32

(52) U.S. Cl. CPC B60H 1/004; B60H 1/00321; B60H 1/00421; B60H 2001/3269; B60H 1/00885; B60H 1/3205; B60H 1/00485

(57) ABSTRACT

A refrigeration cycle device includes a first refrigerant passage from a radiator to an outside heat exchanger, and a second refrigerant passage from the outside heat exchanger to a compressor via a first evaporator. A first expansion valve is disposed in the first refrigerant passage upstream of the outside heat exchanger. A second expansion valve is disposed in the second refrigerant upstream of the first evaporator. The refrigeration cycle device includes a third refrigerant passage that guides the refrigerant flowing between the radiator and the first expansion valve to bypass the first expansion valve and the outside heat exchanger to flow to the second refrigerant passage on the refrigerant flow downstream side of the first evaporator. A third expansion valve is disposed in the third refrigerant passage. A second evaporator is disposed in the third refrigerant passage on the refrigerant flow downstream side of the third expansion valve.

### CROSS REFERENCE TO RELATED APPLICATIONS

The present application is a continuation application of International Patent Application No. PCT/JP2017/015188 filed on Apr. 13, 2017, which designated the U.S. and claims the benefit of priority from Japanese Patent Application No. 2016-119986 filed on Jun. 16, 2016. The entire disclosures of all of the above applications are incorporated herein by reference.

### TECHNICAL FIELD

The present disclosure relates to a refrigeration cycle device.

### BACKGROUND

Generally, in an electric powered vehicle such as an electric vehicle or a hybrid vehicle, the electric power stored in a secondary battery such as a battery pack is supplied to an electric motor via an inverter and the like to output a driving force for driving the vehicle. Electrical devices such as the secondary battery and the inverter are exothermic devices that increase in temperature due to self-generated heat or the like, and as their temperature increases, malfunctions such as operation failures may occur. For this reason, in electric powered vehicles, it is desirable to provide means for cooling the exothermic equipment mounted in the vehicle to an appropriate temperature.

### SUMMARY

In one aspect of the present disclosure, a refrigeration cycle device includes a compressor that compresses and discharges a refrigerant, a radiator that heats a heating target fluid using heat from the compressed refrigerant, an outside heat exchanger, first and second evaporators that cool respective cooling target fluids using the refrigerant, and various expansion valves disposed to selectively decompress and expand the refrigerant at respective locations within the refrigerant cycle.

### BRIEF DESCRIPTION OF THE DRAWINGS

FIG. 1 is an overall configuration diagram of a vehicle air conditioner to which a refrigeration cycle device is applied.

FIG. 2 is a block diagram of a control device of a refrigeration cycle device.

FIG. 3 is a flowchart showing the flow of a mode determination process executed by the control device of the refrigeration.

FIG. 4 is a table showing opening and closing states of each open-close valve in each operation mode when battery cooling is not performed in the refrigeration cycle device.

FIG. 5 is a table showing opening and closing states of each open-close valve in each operation mode when battery cooling is performed in the refrigeration cycle device.

FIG. 6 is an overall configuration diagram of a vehicle air conditioner showing a flow of a refrigerant in a cooling mode in the refrigeration cycle device.

FIG. 7 is an overall configuration diagram of a vehicle air conditioner showing a flow of a refrigerant when battery cooling is performed during a cooling mode in the refrigeration cycle device.

FIG. 8 is an overall configuration diagram of a vehicle air conditioner showing a flow of a refrigerant in a heating mode in the refrigeration cycle device.

FIG. 9 is an overall configuration diagram of a vehicle air conditioner showing a flow of a refrigerant when battery cooling is performed during a heating mode in the refrigeration cycle device.

FIG. 10 is an overall configuration diagram of a vehicle air conditioner showing a flow of a refrigerant in a series dehumidifying heating mode in the refrigeration cycle device.

FIG. 11 is an overall configuration diagram of a vehicle air conditioner showing a flow of a refrigerant when normal battery cooling is performed during a series dehumidifying heating mode in the refrigeration cycle device.

FIG. 12 is a flowchart showing a flow of battery cooling switching process executed by the control device during a series dehumidifying heating mode of the refrigeration cycle device.

FIG. 13 is an overall configuration diagram of a vehicle air conditioner showing a flow of a refrigerant when priority battery cooling is performed during a series dehumidifying heating mode in the refrigeration cycle device.

FIG. 14 is an overall configuration diagram of a vehicle air conditioner showing a flow of a refrigerant in a parallel dehumidifying heating mode in the refrigeration cycle device.

FIG. 15 is an overall configuration diagram of a vehicle air conditioner showing a flow of a refrigerant when battery cooling is performed during a parallel dehumidifying heating mode in the refrigeration cycle device.

FIG. 16 is an overall configuration diagram of a vehicle air conditioner to which a refrigeration cycle device is applied.

FIG. 17 is a flowchart showing a flow of battery cooling switching process executed by a control device during a series dehumidifying heating mode of a refrigeration cycle device.

### DETAILED DESCRIPTION

Hereinafter, embodiments of the present disclosure will be described with reference to the drawings. In the following embodiments, parts, which are the same as or equivalent to those described in the preceding embodiment(s), will be indicated by the same reference signs, and the description thereof may be omitted. Also, in the following embodiments, when only some of the constituent elements are described, corresponding constituent elements of a previously described one or more of the embodiments may be applied to the rest of the constituent elements. The following embodiments may be partially combined with each other even if such a combination is not explicitly described as long as there is no disadvantage with respect to such a combination.

### First Embodiment

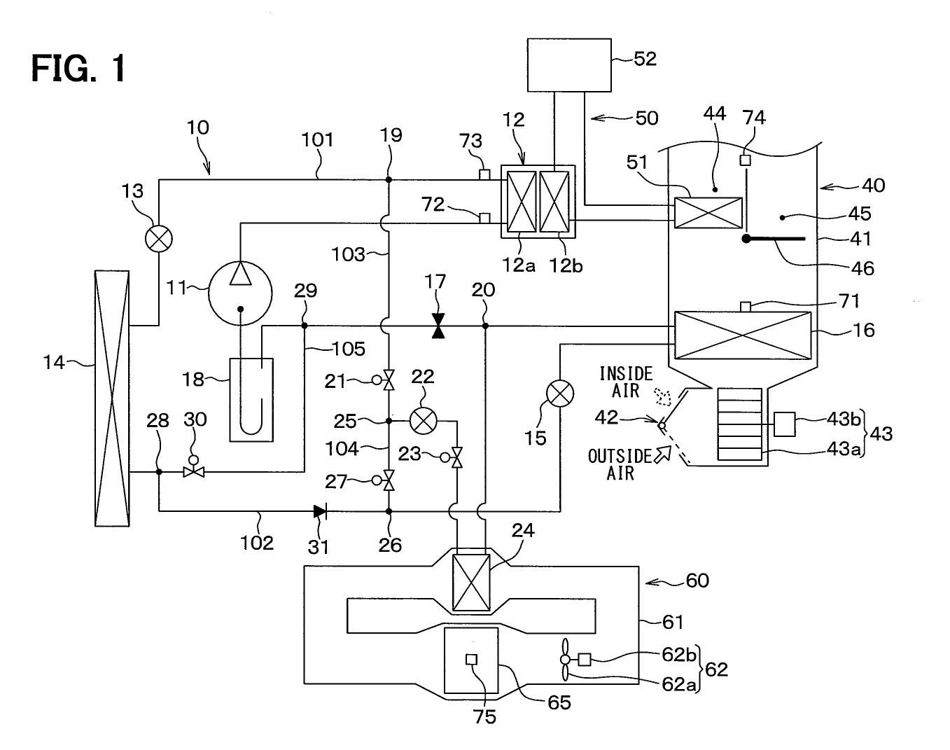

The present embodiment will be described with reference to FIGS. 1 to 15. In the present embodiment, an example will be described in which a refrigeration cycle device 10 of the present disclosure is applied to a vehicle air conditioner of a hybrid vehicle that obtains driving force from an internal combustion engine 52 and from a propulsion electric motor which is not illustrated.

The refrigeration cycle device 10 of the present embodiment, in the vehicle air conditioner, performs a function of adjusting the temperature in a passenger compartment and a function of cooling a secondary battery 65 that stores the electric power to be supplied to the vehicle propulsion electric motor. Specifically, the refrigeration cycle device 10 of the present embodiment is configured to adjust the temperature of the ventilation air to be blown toward the interior of the passenger compartment and to cool the cooling air to be blown to the secondary battery 65. In the present embodiment, the secondary battery 65 is a heat generating device mounted in the vehicle.

The refrigeration cycle device 10 of the present embodiment is configured such that the refrigerant circuit through which the refrigerant flows can be switched in accordance with the operation mode of the air conditioning in the passenger compartment and in accordance with the presence or absence of battery cooling for cooling the secondary battery 65. Specifically, the refrigeration cycle device 10 can be switched between a refrigerant circuit in a cooling mode that cools the passenger compartment, a refrigerant circuit in a heating mode that heats the passenger compartment, or a refrigerant circuit in a dehumidifying heating mode for heats and dehumidifies the passenger compartment. Furthermore, while performing the operation modes for air conditioning the passenger compartment, the refrigeration cycle device 10 can be switched to a refrigerant circuit that cools the secondary battery 65.

Among the component devices of the refrigeration cycle device 10, the compressor 11 compresses intake refrigerant and discharges the refrigerant. The compressor 11 is disposed in the engine compartment of the vehicle. The compressor 11 of the present embodiment is an electric compressor that drives a fixed displacement type compression mechanism having a fixed discharge capacity with an electric motor. The rotation speed of the electric motor of the compressor 11 is controlled in accordance with a control signal from a control device 70 which is described later.

Here, in the refrigeration cycle device 10, an HFC refrigerant (for example, R134a) is used as the refrigerant. The refrigeration cycle device 10 of the present embodiment is a vapor compression type subcritical refrigeration cycle in which the refrigerant pressure on the high pressure side of the cycle does not exceed the critical pressure of the refrigerant. Note that the refrigeration cycle device 10 is not limited to HFC refrigerants, and an HFO refrigerant (for example, R1234yf) or the like may be used instead.

A water-refrigerant heat exchanger 12 is connected to a discharge port side of the compressor 11. The water-refrigerant heat exchanger 12 is a radiator that exchanges heat between the refrigerant discharged from the compressor 11 and cooling water for the internal combustion engine 52, which is a heating target fluid, to dissipate heat.

Specifically, the water-refrigerant heat exchanger 12 indirectly dissipates heat in the refrigerant discharged from the compressor 11 to ventilation air blown into the passenger compartment via the cooling water, thereby heating the ventilation air to be blown into the passenger compartment.

The water-refrigerant heat exchanger 12 of this embodiment includes a refrigerant side passage 12a through which the refrigerant discharged from the compressor 11 flows, and a cooling water side passage 12b through which the cooling water, which flows through a cooling water circuit 50, flows.

The refrigerant side passage 12a is provided between the compressor 11 and a heating expansion valve 13 in the refrigeration cycle device 10. Specifically, the refrigerant inlet side of the refrigerant side passage 12a is connected to the discharge port side of the compressor 11, and the refrigerant outlet side of the refrigerant side passage 12a is connected to the refrigerant inlet side of the heating expansion valve 13.

The cooling water inlet side of the cooling water side passage 12b is connected to the cooling water outlet side of the internal combustion engine 52 such that the cooling water, after passing through the internal combustion engine 52, flows into the cooling water side passage 12b. The cooling water outlet side of the cooling water side passage 12b is connected to the cooling water inlet side of a heater core 51 such that the cooling water, after having its temperature rise due to heat exchange with the refrigerant, flows into the heater core 51.

The heater core 51 is a heating heat exchanger that heats the air to be blown into the passenger compartment by exchanging heat between the cooling water and the air to be blown into the passenger compartment.

A first refrigerant passage 101 is connected to the water-refrigerant heat exchanger 12 to guide the refrigerant flowing out from the refrigerant side passage 12a to an outside heat exchanger 14 which is described later. The heating expansion valve 13 is provided in the first refrigerant passage 101.

The heating expansion valve 13 is an expansion valve that decompresses and expands the refrigerant that will flow into the outside heat exchanger 14, which will be described later, in a heating mode or the like during which the passenger compartment is heated. Specifically, the heating expansion valve 13 is an electric expansion valve which includes a valve body that sets a throttle opening degree and an electric actuator including a stepper motor configured to change the throttle opening degree by displacing the valve body. The operation of the heating expansion valve 13 is controlled according to a control signal from a control device 70 to be described later.

The throttle opening degree of the heating expansion valve 13 of the present embodiment may be fully opened to act as a variable throttle mechanism with a fully open function that substantially does not exhibit a decompression expansion effect on the refrigerant. In the present embodiment, the heating expansion valve 13 is a first expansion valve that can decompress and expand the refrigerant flowing into the outside heat exchanger 14.

A refrigerant outlet side of the heating expansion valve 13 is connected to a refrigerant inlet side of the outside heat exchanger 14. The outside heat exchanger 14 is a heat exchanger that exchanges heat between the refrigerant flowing therein and outside air supplied from a non-illustrated supply fan.

Specifically, during a heating mode or the like in which the passenger compartment is heated, the outside heat exchanger 14 functions as a heat absorber that exerts a heat absorbing action by evaporating the refrigerant, and during a cooling mode or the like in which the passenger compartment is cooled, the outside heat exchanger 14 functions as a radiator that exerts a heat radiation effect by condensing the refrigerant.

The refrigerant outlet side of the outside heat exchanger 14 is connected to a second refrigerant passage 102 for guiding the refrigerant flowing out of the outside heat exchanger 14 to a refrigerant suction side of the compressor 11 via an air conditioning evaporator 16 to be described later. A cooling expansion valve 15 is provided in the second refrigerant passage 102.

The cooling expansion valve 15 is an expansion valve that decompresses and expands the refrigerant that will flow into the air conditioning evaporator 16, which will be described later, in a cooling mode or the like during which the passenger compartment is cooled. Specifically, the cooling expansion valve 15 is an electric expansion valve which includes a valve body that sets a throttle opening degree and an electric actuator including a stepper motor configured to change the throttle opening degree by displacing the valve body. The operation of the cooling expansion valve 15 is controlled according to a control signal from a control device 70 to be described later.

The throttle opening degree of the cooling expansion valve 15 of the present embodiment may be fully opened to act as a variable throttle mechanism with a fully open function that substantially does not exhibit a decompression expansion effect on the refrigerant. Further, the throttle opening degree of the cooling expansion valve 15 of the present embodiment may be fully closed to act as a variable throttle mechanism with a fully closed function capable of cutting off the inflow of refrigerant into the air conditioning evaporator 16. In the present embodiment, the cooling expansion valve 15 is a second expansion valve that can decompress and expand the refrigerant flowing into the air conditioning evaporator 16 which is a first evaporator.

A refrigerant outlet side of the cooling expansion valve 15 is connected to a refrigerant inlet side of the air conditioning evaporator 16. The air conditioning evaporator 16 is arranged on the air flow upstream side of the heater core 51 in an air conditioning case 41 of an indoor air conditioning unit 40. The air conditioning evaporator 16 evaporates the refrigerant, which was decompressed and expanded by the cooling expansion valve 15, by exchanging heat with the air prior to being heated by the heater core 51, to cool the air prior to being heated by the heater core 51. In the present embodiment, the air conditioning evaporator 16 is a first evaporator that cools ventilation air by exchanging heat between refrigerant and the ventilation air to be blown into the passenger compartment to evaporate the refrigerant. Further, in the present embodiment, the ventilation air to be blown into the passenger compartment is a first cooling target fluid.

A refrigerant outlet side of the air conditioning evaporator 16 is connected to a refrigerant inlet side of an accumulator 18 via a pressure regulating valve 17. The pressure regulating valve 17 is a constant pressure valve that operates so as to maintain the refrigerant pressure of the air conditioning evaporator 16 at a predetermined pressure.

The accumulator 18 is a gas-liquid separator that separates the gas-liquid of the refrigerant flowing into the accumulator 18, causes the gas-phase refrigerant to flow out toward the refrigerant suction side of the compressor 11, and is capable of storing liquid-phase refrigerant as excess refrigerant.

Here, in the refrigeration cycle device 10 of the present embodiment, a third refrigerant passage 103 is provided to guide the refrigerant flowing between the water-refrigerant heat exchanger 12 and the heating expansion valve 13 to bypass the outside heat exchanger 14 and to flow into the second refrigerant passage 102 on the refrigerant flow downstream side of the air conditioning evaporator 16.

Specifically, one end side of the third refrigerant passage 103 is connected to a first three-way junction 19 provided between the water-refrigerant heat exchanger 12 and the heating expansion valve 13 in the first refrigerant passage 101. Further, the other end side of the third refrigerant passage 103 is connected to a second three-way junction 20 provided between the air conditioning evaporator 16 and the pressure regulating valve 17 in the second refrigerant passage 102.

In the third refrigerant passage 103, a first passage opening/closing valve 21 that opens and closes the third refrigerant passage 103 is provided. The first passage opening/closing valve 21 is a solenoid valve whose opening and closing state is controlled according to a control signal outputted from the control device 70 to be described later.

Further, in the third refrigerant passage 103, a refrigeration expansion valve 22 is provided on the refrigerant flow downstream side of the first passage opening/closing valve 21. The refrigeration expansion valve 22 is an expansion valve that decompresses and expands the refrigerant that will below into a battery evaporator 24, which will be described later, when cooling the secondary battery 65.

Specifically, the refrigeration expansion valve 22 is an electric expansion valve which includes a valve body that sets a throttle opening degree and an electric actuator including a stepper motor configured to change the throttle opening degree by displacing the valve body. The operation of the refrigeration expansion valve 22 is controlled according to a control signal from a control device 70 to be described later. In the present embodiment, the refrigeration expansion valve 22 is a third expansion valve that can decompress and expand the refrigerant flowing into the battery evaporator 24 which is a second evaporator.

On the refrigerant outlet side of the refrigeration expansion valve 22, a battery opening/closing valve 23 is provided for opening and closing a refrigerant passage in the third refrigerant passage 103 between the refrigeration expansion valve 22 and the battery evaporator 24 which is described later. The battery opening/closing valve 23 is a solenoid valve whose opening and closing state is controlled according to a control signal outputted from the control device 70 to be described later.

A refrigerant outlet side of the battery opening/closing valve 23 is connected to a refrigerant inlet side of the battery evaporator 24. The battery evaporator 24 is arranged inside a battery case 61 of a battery pack 60. This battery evaporator 24 is a battery cooling evaporator that cools the cooling air to be blown to the secondary battery 65 by exchanging heat between the refrigerant, which was decompressed and expanded by the refrigeration expansion valve 22, with the cooling air.

In the present embodiment, the battery evaporator 24 is a second evaporator that performs heat exchange between the refrigerant and the cooling air to be blown to the secondary battery 65 to evaporate the refrigerant. Further, in the present embodiment, the cooling air to be blown to the secondary battery 65 is a second cooling target fluid.

In the refrigeration cycle device 10, a fourth refrigerant passage 104 is provided to communicate a portion in the third refrigerant passage 103 between the first passage opening/closing valve 21 and the refrigeration expansion valve 22 to a portion in the second refrigerant passage 102 between the outside heat exchanger 14 and the cooling expansion valve 15.

Specifically, one end side of the fourth refrigerant passage 104 is connected to a third three-way junction 25 provided in the third refrigerant passage 103 between the first passage opening/closing valve 21 and the refrigeration expansion valve 22. Further, the other end side of the fourth refrigerant passage 104 is connected to a fourth three-way junction 26 provided in the second refrigerant passage 102 between the outside heat exchanger 14 and the cooling expansion valve 15.

A second passage opening/closing valve 27 for opening and closing the fourth refrigerant passage 104 is provided in the fourth refrigerant passage 104. The second passage opening/closing valve 27 is a solenoid valve whose opening and closing state is controlled according to a control signal outputted from the control device 70 to be described later.

Further, in the refrigeration cycle device 10, a bypass passage 105 is provided to communicate a portion of the second refrigerant passage 102 on the refrigerant flow upstream side of the fourth three-way junction 26, which is a connection portion with the fourth refrigerant passage 104, to a portion of the second refrigerant passage 102 on the refrigerant flow downstream side of the air conditioning evaporator 16.

Specifically, one end side of the bypass passage 105 is connected to a fifth three-way junction 28 provided in the second refrigerant passage 102 between the outside heat exchanger 14 and the fourth three-way junction 26. Further, the other end side of the bypass passage 105 is connected to a sixth three-way junction 29 provided in the second refrigerant passage 102 between the pressure regulating valve 17 and the accumulator 18.

A bypass passage opening/closing valve 30 for opening and closing the bypass passage 105 is provided in the bypass passage 105. The bypass opening/closing valve 30 is a solenoid valve whose opening and closing state is controlled according to a control signal outputted from the control device 70 to be described later.

Further, in the second refrigerant passage 102, a check valve 31 is provided between the fifth three-way junction 28, which is the connection portion of the bypass passage 105 to the second refrigerant passage 102, and the fourth three-way junction 26, which is the connection portion of the fourth refrigerant passage 104 to the second refrigerant passage 102.

The check valve 31 is a device that prevents refrigerant from flowing from the fourth refrigerant passage 104 to the bypass passage 105 via the second refrigerant passage 102. In other words, in the second refrigerant passage 102, the check valve 31 is configured to allow the refrigerant to flow in one direction from the fifth three-way junction 28 to the fourth three-way junction 26.

Next, the inside air conditioning unit 40 will be described. The indoor air conditioning unit 40 is a unit that blows out temperature adjusted air into the passenger compartment. The indoor air conditioning unit 40 is disposed inside an instrument panel at the front area in the passenger compartment. The indoor air conditioning unit 40 is formed by housing an air conditioning blower 43, the air conditioning evaporator 16, the heater core 51, and the like inside the air conditioning case 41 forming an outer shell.

In the air conditioning case 41, an air passage for the air to be blown into the passenger compartment is formed. The air conditioning case 41 is formed of a resin (for example, polypropylene) having a certain degree of elasticity and also excellent in strength.

On the air flow most-upstream side of the air conditioning case 41, an inside/outside air switching device 42 is disposed to vary the air volume ratio between the air volume of passenger compartment air (that is, inside air) and the air volume of outside passenger compartment air (that is, outside air) introduced into the air conditioning case 41.

The air conditioner blower 43, which blows the air introduced through the inside/outside air switching device 42 toward the passenger compartment, is disposed on the air flow downstream side of the inside/outside air switching device 42. The air conditioner blower 43 is an electric blower which drives a fan 43a for generating an air current with an electric motor 43b. The rotation speed of the air conditioner blower 43 is controlled in accordance with a control signal from the control device 70 which is described later.

The fan 43a of the air conditioning blower 43 is a centrifugal multi-blade fan (that is, a sirocco fan). It should be noted that the fan 43a is not limited to a centrifugal multi-blade fan, but may be an axial flow fan, a cross flow fan, or the like instead.

The air conditioning evaporator 16 and the heater core 51 are disposed on the air flow downstream side of the air conditioning blower 43 in the order of the air conditioning evaporator 16 followed by the heater core 51 with respect to the flow of the ventilation air. In other words, the heater core 51 is disposed on the air flow downstream side of the air conditioning evaporator 16.

Here, the heater core 51 is disposed in the cooling water circuit 50 through which the cooling water of the internal combustion engine 52, which outputs driving force for driving the vehicle, circulates. The heater core 51 is a heating heat exchanger that heats the air that passed through the air conditioning evaporator 16 by exchanging heat between the cooling water flowing out of the water-refrigerant heat exchanger 12 and the air that passed through the air conditioning evaporator 16.

The heater core 51 according to the present embodiment is connected to the cooling water flow downstream side of the water-refrigerant heat exchanger 12 in the cooling water circuit 50, such that the cooling water, after passing through both the internal combustion engine 52 and the water-refrigerant heat exchanger 12, flows into the heater core 51.

Although not illustrated, a water pump is disposed in the cooling water circuit 50 for supplying cooling water, in the order, to the internal combustion engine 52, the water-refrigerant heat exchanger 12, and the heater core 51. Further, although not illustrated, the cooling water circuit 50 is provided with a bypass passage that allows the cooling water to bypass the water-refrigerant heat exchanger 12 during the cooling mode in which air is not heated by the heater core 51.

In the air conditioning case 41 of the present embodiment, a warm air passage 44 and a cool air bypass passage 45 are provided on the air flow downstream side of the air conditioning evaporator 16. The warm air passage 44 allows air to flow to the heater core 51, and the cool air bypass passage 45 allows air to bypass the heater core 51.

Further, in the air conditioning case 41, an air mix door 46 is disposed on the air flow downstream side of the air conditioning evaporator 16 and on the air flow upstream side of the heater core 51. The air mix door 46 is a device that adjusts the air volume ratio between the air volume of ventilation air flowing in the warm air passage 44 and the air volume of ventilation air flowing in the cold air bypass passage 45.

The temperature of the air blown into the passenger compartment varies according to the air volume ratio of the ventilation air flowing through the warm air passage 44 to the air volume of the ventilation air flowing through the cold air bypass passage 45. Therefore, the air mix door 46 functions as a temperature adjusting unit that adjusts the temperature of the air blown into the passenger compartment. Further, the operation of the air mix door 46 is controlled by a control signal output from the control device 70.

Further, on the air flow downstream side of the warm air passage 44 and the cold air bypass passage 45, a mixing space (not illustrated) is provided to combine the air that passed through the warm air passage 44 and the air that passed through the cold air bypass passage 45.

A plurality of opening holes are formed at the air flow most downstream portion of the air conditioning case 41 to blow out the ventilation air that merged in the mixing space into the passenger compartment. Although not illustrated, the air conditioning case 41 is provided with, as the opening holes, a defroster opening hole that blows air toward the inner surface of the window glass on the front of the vehicle, a face opening hole that blows air conditioned air toward the upper body of a passenger in the passenger compartment, and a foot opening hole that blows air conditioned air toward the feet of the passenger.

Further, although not illustrated, a defroster door, a face door, and a foot door are provided on the air flow upstream side of each opening hole as blowing mode doors for adjusting the opening area of each opening hole. These blowout mode doors are driven by actuators whose operation are controlled by a control signal output from the control device 70 via a link mechanism or the like which is not illustrated.

Next, the battery pack 60 will be described. The battery pack 60 is disposed toward the bottom surface of the vehicle, for example, between the rear seats and the trunk at the rear end of the vehicle. The battery pack 60 includes a metallic battery case 61 that is electrically insulated.

In the battery case 61, an air passage through which cooling air for cooling the secondary battery 65 circulates is formed. In addition, inside the battery case 61, a battery blower 62, the secondary battery 65, the battery evaporator 24 and the like are housed.

The battery blower 62 blows the cooling air cooled by the battery evaporator 24 to the secondary battery 65. The battery blower 62 is an electric blower which drives a fan 62a for generating an air current with an electric motor 62b. The rotation speed of the battery blower 62 is controlled in accordance with a control signal from the control device 70 which is described later.

The secondary battery 65 is formed by connecting a plurality of series connection cells in parallel. The secondary battery 65 may be, for example, a lithium-ion battery. The secondary battery 65 tends to deteriorate as the battery temperature increases. For this reason, it is necessary for the secondary battery 65 to be temperature adjusted such that the battery temperature is, for example, 40° C. or less.

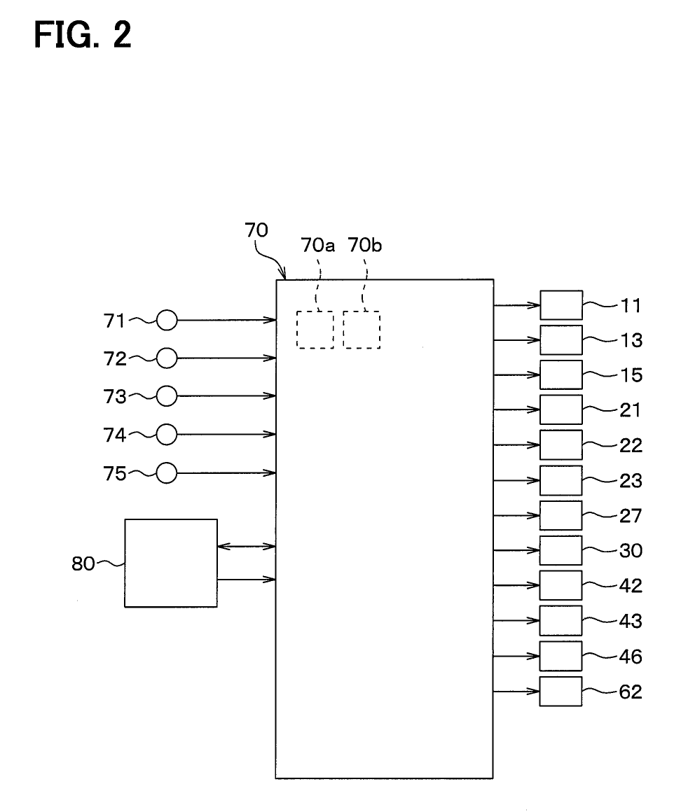

Next, the control device 70 of the refrigeration cycle device 10 of the present embodiment will be described with reference to FIG. 2. The control device 70 includes a microcomputer including a CPU, a storage unit such as ROM or RAM, and other peripheral circuits.

The control device 70 performs various calculations and processes based on control programs stored in the storage unit. The control device 70 controls the operation of the various control equipment 11, 13, 15, 21, 22, 23, 27, 30, 42, 43, 46, 62 connected to the output side of the control device 70. The storage unit of the control device 70 is formed of non-transitory tangible storage media.

Although not shown in the drawing, an air conditioning control sensor group including an inside air sensor that detects an inside air temperature Tr, an outside air sensor that detects an outside air temperature Tam, a solar radiation sensor that detects an amount of solar radiation As entering the passenger compartment, and the like is connected at the input side of the control device 70.

A first temperature sensor 71 that detects an air temperature Te of the air after passing through the air conditioning evaporator 16 is connected to the input side of the control device 70. Further, a second temperature sensor 72 that detects a temperature Td of the high pressure refrigerant flowing into the water-refrigerant heat exchanger 12, a refrigerant pressure sensor 73 that detects a refrigerant pressure Pd of the refrigerant after passing through the water-refrigerant heat exchanger 12, and the like are connected to the input side of the control device 70. In addition, a blowout temperature sensor 74 that detects a blowout air temperature TAV of the air blown into the passenger compartment, a battery temperature sensor 75 that detects a battery temperature Tb of the secondary battery 65, and the like are connected to the input side of the control device 70.

As the first temperature sensor 71 of the present embodiment, a sensor that detects the temperature of the heat exchange fins of the air conditioning evaporator 16 or a sensor that detects the temperature of the refrigerant flowing through the air conditioning evaporator 16 are contemplated, and these or other sensors may be used. In addition, in the present embodiment, an example is described in which the blowout air temperature TAV is detected by the blowout temperature sensor 74, but this example is not limiting. For example, as an alternative, the blowout air temperature TAV may be calculated based on the detection value of the first temperature sensor 71, the detection value of the second temperature sensor 72, and the like.

Further, an operation panel 80 provided with various air conditioning operation switches is connected to the input side of the control device 70. Operation signals output from the various operation switches of the operation panel 80 are input to the control device 70. The operation panel 80 includes, as the various air conditioning operation switches, an actuation switch for the vehicle air conditioner, a temperature setting switch configured to set a target temperature, an A/C switch configured to set whether the air conditioning evaporator 16 cools air, and the like.

Here, the control device 70 of the present embodiment is a device which is a collection of a plurality of controllers formed by hardware and software for controlling various control equipment connected to the output side of the control device 70.

The control device 70 includes a mode determining unit 70a which determines the operation mode of air conditioning in the passenger compartment and whether to perform battery cooling, and a switching control unit 70b which changes the opening and closing states of the opening/closing valves 21, 23, 27, 30 to switch the refrigerant circuit in the cycle. In the present embodiment, each of the opening/closing valves 21, 23, 27, 30 constitutes a circuit switching device for switching the refrigerant circuit through which the refrigerant flows. Further, in the present embodiment, the switching control unit 70b constitutes an opening/closing control unit that controls the first passage opening/closing valve 21 and the second passage opening/closing valve 27.

Next, the operation of the refrigeration cycle device 10 in the above configuration will be described. The refrigeration cycle device 10 of the present embodiment is capable of air conditioning the passenger compartment and cooling the secondary battery 65.

A cooling mode, a heating mode, a series dehumidifying heating mode, and a parallel dehumidifying heating mode may be set as the operation mode of air conditioning in the passenger compartment. The operation mode is switched by the control device 70 executing control programs stored in the storage unit.

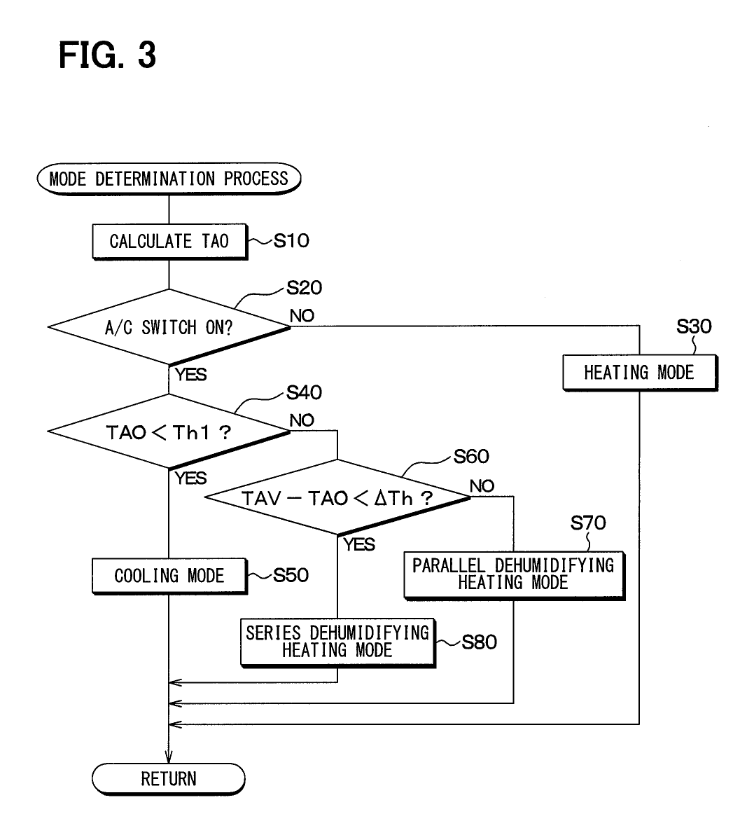

Hereinafter, a mode switching process for switching the operation mode, which is executed by the control device 70, will be described with reference to the flowchart of FIG. 3. FIG. 3 is a flowchart showing the flow of a mode switching process executed by the control device 70. Each of the control steps shown in FIG. 3 constitutes a functional unit for implementing various functions and is executed by the control device 70.

When the operation switch of the vehicle air conditioner is turned on, as shown in FIG. 3, the control device 70 calculates a target blowout temperature TAO of the air blown into the passenger compartment based on the detection values of the various sensors in step S10.

The control device 70 may, for example, calculate the target blowout temperature TAO based on the following formula F1.

TAO=Kset×Tset−Kr×Tr−Kam×Tam−Ks×As+C (F1)

Here, Tset in Formula F1 is a set temperature in the passenger compartment and is set by a temperature setting switch. Further, Kset, Kr, Kam, Ks in Formula F1 are predetermined control gain values. In addition, C in Formula F1 is a correction constant.

Subsequently, in step S20, the control device 70 determines whether or not the A/C switch is ON. When it is determined that the A/C switch is not turned on, the control device 70 determines in step S30 that the operation mode is the heating mode. This heating mode is an operation mode in which the ventilation air blown into the passenger compartment is not cooled by the air conditioning evaporator 16, but is heated by the heater core 51 and blown into the passenger compartment.

When it is determined that the A/C switch is turned on in the determination processing of step S20, the control device 70 determines in step S40 whether the target blowout temperature TAO is lower than a predetermined cooling determination threshold value Th1. When it is determined that the target blowout temperature TAO is lower than the cooling determination threshold Th1, the control device 70 determines in step S50 that the operation mode is the cooling mode. This cooling mode is an operation mode in which the ventilation air blown into the passenger compartment is cooled by the air conditioning evaporator 16, and then blown into the passenger compartment without passing through the heater core 51. The cooling determination threshold value Th1 may, for example, be set to a temperature in the vicinity of the set temperature Tset in the passenger compartment as set by the temperature setting switch.

When it is determined, in the determination processing of step S40, that the target blowout temperature TAO is equal to or greater than the cooling determination threshold Th1, the control device 70 then determines in step S60 whether or not the temperature difference between the blowout air temperature TAV and the target blowout temperature TAO is smaller than a predetermined determination threshold value ΔTh.

When it is determined, as a result of the determination processing of step S60, that the temperature difference between the blowout air temperature TAV and the target blowout temperature TAO is equal to or greater than the determination threshold ΔTh, the control device 70 then determines in step S70 that the operation mode is the parallel dehumidifying heating mode. The parallel dehumidifying heating mode is an operation mode in which, during a dehumidifying heating mode, the temperature of the air blown into the passenger compartment can be maximized.

Conversely, when it is determined, as a result of the determination processing of step S60, that the temperature difference between the blowout air temperature TAV and the target blowout temperature TAO is less than the determination threshold ΔTh, the control device 70 then determines in step S80 that the operation mode is the series dehumidifying heating mode.

Here, the series dehumidifying heating mode is an operation mode in which, as compared to the parallel dehumidifying heating mode, the temperature of the air blown into the passenger compartment can be decreased. In other words, the parallel dehumidifying heating mode is an operation mode in which, as compared to the series dehumidifying heating mode, the temperature of the air blown into the passenger compartment can be increased.

As described above, the refrigeration cycle device 10 of the present embodiment is configured to be switchable between the cooling mode, the heating mode, the series dehumidifying heating mode, and the parallel dehumidifying heating mode according to the air conditioning environment.

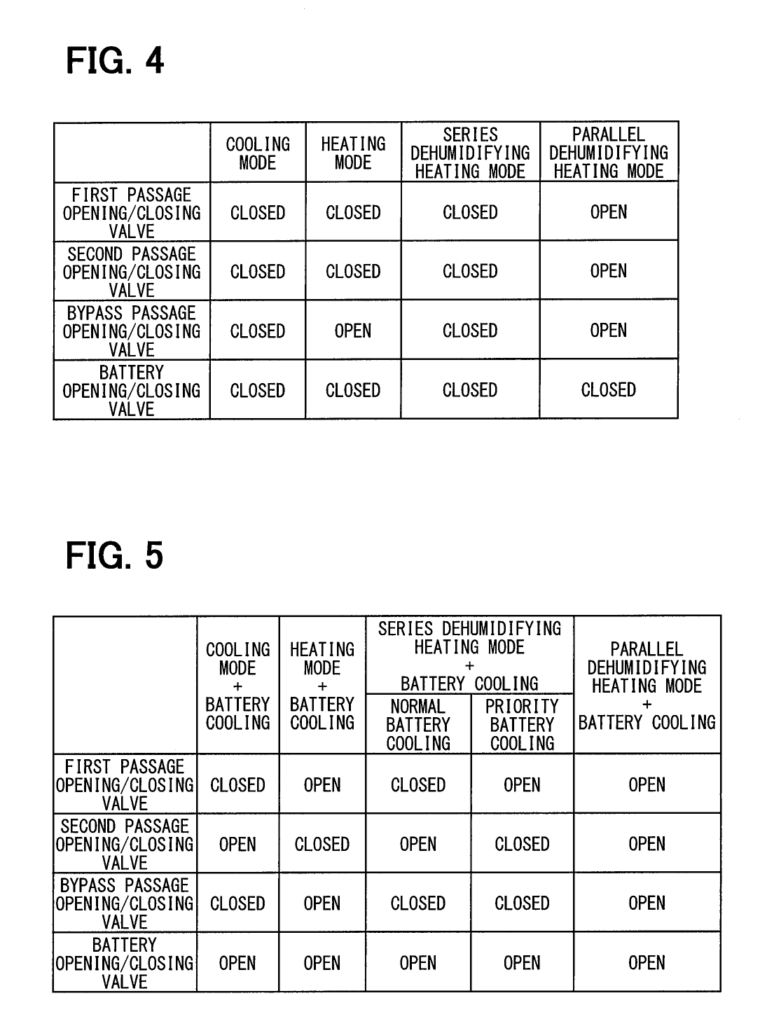

Specifically, as shown in FIG. 4, the control device 70 controls the various opening/closing valves 21, 23, 27, 30 to switch the refrigerant circuit through which the refrigerant flows between refrigerant circuits corresponding to the cooling mode, the heating mode, the serial dehumidifying heating mode, and the parallel dehumidifying heating mode.

Further, when executing the operation mode determined in the mode determination process, if the battery temperature Tb of the secondary battery 65 is equal to or higher than a predetermined high temperature side reference temperature Tbh (for example, 30° C.), the refrigeration cycle device 10 of the present embodiment performs battery cooling to cool the secondary battery 65.

Specifically, as shown in FIG. 5, when battery cooling is performed, the control device 70 controls the various opening/closing valves 21, 23, 27, 30 to switch between refrigerant circuits corresponding to the cooling mode, the heating mode, the dehumidifying heating mode, and the parallel dehumidifying heating mode, all of which also include battery cooling. Hereinafter, the operation of the refrigeration cycle device 10 in each operation mode will be described.

(A) Cooling Mode

First, the operation of the refrigeration cycle device 10 when battery cooling is not performed during the cooling mode will be described. In this cooling mode, as shown in FIG. 4, the control device 70 controls the respective opening/closing valves 21, 23, 27, 30 to be closed. In addition, the control device 70 controls the throttle opening degree of the heating expansion valve 13 to be in a fully opened state, and controls the cooling expansion valve 15 so as to be in a throttling state.

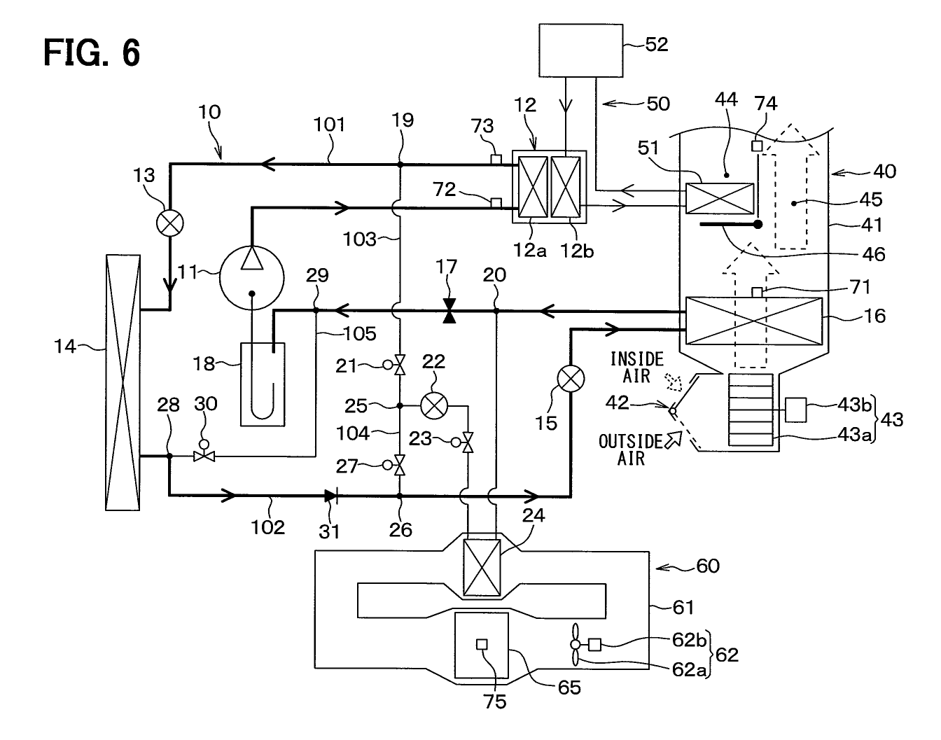

As a result, in the refrigeration cycle device 10, the refrigerant circuit in the cycle becomes a circuit in which the refrigerant flows as indicated by the black thick line with arrows in FIG. 6. In this refrigerant circuit, the control device 70 determines the operation states (e.g. control signals) of the various control equipment connected to the output side of the control device 70.

For example, the control device 70 may determine the control signal to be output to the compressor 11 in the following manner. First, the control device 70 determines the target evaporator temperature TEO of the air conditioning evaporator 16 with reference to a control map, which is stored in advance in the storage unit, based on the target blowout temperature TAO. Then, based on the deviation between the target evaporator temperature TEO and the detection value of the first temperature sensor 71, the control device 70 determines a control signal to be output to the compressor 11 such that the air temperature Te of the air conditioning evaporator 16 approaches the target evaporator temperature TEO. Further, the target evaporator temperature TEO is determined so as to be equal to or higher than a temperature capable of preventing frost formation at the air conditioning evaporator 16 (for example, 1° C.)

Further, the control device 70 determines the control signal to be output to the air conditioning blower 43 by referring to the control map, which is stored in advance in the storage unit, based on the target blowout temperature TAO. For example, the control device 70 may determine the control signal so as to set the air volume of the air conditioning blower 43 to a maximum air volume when the target blowout temperature TAO is a low temperature or a high temperature, and so that the air volume of the air conditioning blower 43 decreases as the target blowout temperature TAO approaches an intermediate temperature.

Further, regarding the control signal to be output to the cooling expansion valve 15, the control device 70 determines the control signal such that the supercooling degree of the refrigerant flowing into the cooling expansion valve 15 approaches a target supercooling degree at which the coefficient of performance (i.e., COP) of the cycle substantially reaches a maximum value.

Further, the control device 70 controls the air mix door 46 to a position of closing the warm air passage 44. It should be noted that the control device 70 may control the air mix door 46 such that the blowout air temperature TAV approaches the target blowout temperature TAO through feedback control or the like.

The control device 70 outputs the control signals determined as described above to the various control equipment. As a result, the refrigerant discharged from the compressor 11 flows into the refrigerant side passage 12a of the water-refrigerant heat exchanger 12.

The cooling water circuit 50 of the present embodiment is configured such that during the cooling mode, the cooling water bypasses the water-refrigerant heat exchanger 12. As a result, the refrigerant that flows into the water-refrigerant heat exchanger 12 will flow out from the water-refrigerant heat exchanger 12 without radiating heat to the cooling water. In addition, during the cooling mode, since the warm air passage 44 is closed by the air mix door 46, the air in the air conditioning case 41 is blown out into the passenger compartment without being heated by the heater core 51.

Since the heating expansion valve 13 is in the fully open state, the refrigerant that flows out of the water-refrigerant heat exchanger 12 will flow into the outside heat exchanger 14 mostly without being decompressed and expanded by the heating expansion valve 13. Further, during the cooling mode, since the first passage opening/closing valve 21 is in the closed state, no refrigerant flows through the third refrigerant passage 103.

The refrigerant that flows into the outside heat exchanger 14 exchanges heat with the outside air to dissipate heat. Then, the refrigerant that flows out of the outside heat exchanger 14 will flow into the cooling expansion valve 15 via the check valve 31 to be decompressed and expanded. Further, during the cooling mode, since the bypass passage opening/closing valve 30 and the second passage opening/closing valve 27 are in the closed state, no refrigerant flows through the fourth refrigerant passage 104 or the bypass passage 105.

The refrigerant that flows out from the cooling expansion valve 15 then will then flow into the air conditioning evaporator 16, absorb heat from the ventilation air to be blown into the passenger compartment, and evaporate. As a result, the ventilation air to be blown into the passenger compartment is cooled and dehumidified.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again. Further, the liquid-phase refrigerant separated by the accumulator 18 is stored in the accumulator 18 as an surplus refrigerant which is not necessary for the refrigeration cycle device 10 to exhibit the required refrigerating capacity. This also applies to the other operation modes to be described later.

As described above, in the case where battery cooling is not performed during the cooling mode, a refrigerant circuit is formed in which the refrigerant which is heat dissipated by the outside heat exchanger 14 is then evaporated in the air conditioning evaporator 16. For this reason, in the case where battery cooling is not performed during the cooling mode, air is cooled by the air conditioning evaporator 16 and then blown into the passenger compartment. Accordingly, cooling of the passenger compartment may be performed.

(B) Cooling Mode+Battery Cooling

Next, the operation of the refrigeration cycle device 10 when battery cooling is performed during the cooling mode will be described. In this cooling mode, as shown in FIG. 5, the control device 70 controls the first passage opening/closing valve 21 and the bypass passage opening/closing valve 30 to be in the closed state, and controls the second passage opening/closing valve 27 and the battery opening/closing valve 23 to be in the open state. In addition, the control device 70 controls the throttle opening degree of the heating expansion valve 13 to be in a fully opened state, and controls the cooling expansion valve 15 and the refrigeration expansion valve 22 so as to be in a throttling state.

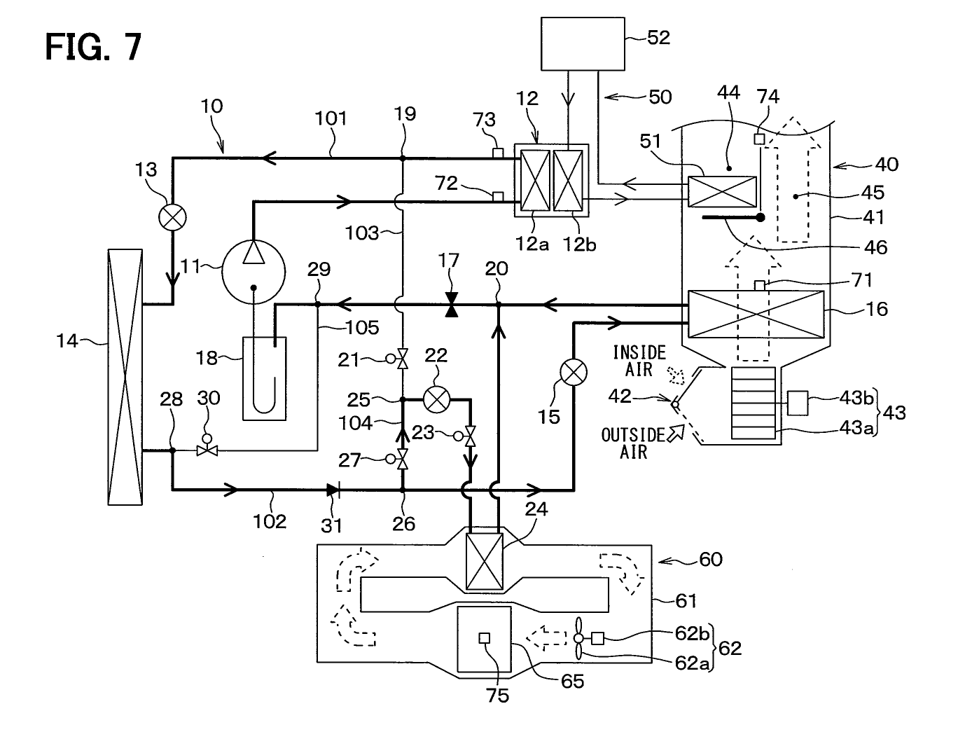

As a result, in the refrigeration cycle device 10, the refrigerant circuit in the cycle becomes a circuit in which the refrigerant flows as indicated by the black thick line with arrows in FIG. 7. In this refrigerant circuit, the control device 70 determines the operation states (e.g. control signals) of the various control equipment connected to the output side of the control device 70.

Regarding the control signal to be output to the refrigeration expansion valve 22, the control device 70 may, for example, determine the control signal such that the flow rate of the refrigerant in the battery evaporator 24 increases when the battery temperature Tb of the secondary battery 65 is high. In other words, the control device 70 controls the throttle opening degree of the refrigeration expansion valve 22 to increase as the battery temperature Tb of the secondary battery 65 increases.

Further, regarding the control signal to be output to the battery blower 62, the control device 70 determines the control signal such that the amount of air blown to the secondary battery 65 is a predetermined air volume that is determined in advance. Further, the control signals to be outputted to the other control equipment are determined in the same manner as in the previously described cooling mode.

The control device 70 outputs the control signals determined as described above to the various control equipment. As a result, the refrigerant discharged from the compressor 11 flows into the refrigerant side passage 12a of the water-refrigerant heat exchanger 12.

The cooling water circuit 50 of the present embodiment is configured such that during the cooling mode, the cooling water bypasses the water-refrigerant heat exchanger 12. As a result, the refrigerant that flows into the water-refrigerant heat exchanger 12 will flow out from the water-refrigerant heat exchanger 12 without radiating heat to the cooling water. Further, during the cooling mode, since the warm air passage 44 is closed by the air mix door 46, the air in the air conditioning case 41 is blown out into the passenger compartment without being heated by the heater core 51.

Since the heating expansion valve 13 is in the fully open state, the refrigerant that flows out of the water-refrigerant heat exchanger 12 will flow into the outside heat exchanger 14 mostly without being decompressed and expanded by the heating expansion valve 13. Further, during the cooling mode, since the first passage opening/closing valve 21 is in the closed state, no refrigerant flows through the third refrigerant passage 103.

The refrigerant that flows into the outside heat exchanger 14 exchanges heat with the outside air to dissipate heat. The refrigerant that flows out from the outside heat exchanger 14 will then flow into both the cooling expansion valve 15 and the refrigeration expansion valve 22 because both the second passage opening/closing valve 27 and the battery opening/closing valve 23 are in the open state. Further, during the cooling mode, since the bypass passage opening/closing valve 30 is in the closed state, no refrigerant flows through the bypass passage 105.

The refrigerant that flows from the outside heat exchanger 14 toward the cooling expansion valve 15 flows into the cooling expansion valve 15 and is decompressed and expanded. Then, in the air conditioning evaporator 16, this refrigerant absorbs heat from the ventilation air to be blown into the passenger compartment and evaporates. As a result, the ventilation air to be blown into the passenger compartment is cooled and dehumidified.

The refrigerant flowing out from the air conditioning evaporator 16 then flows into the accumulator 18 via the pressure regulating valve 17. Then, the gas-phase refrigerant separated by the accumulator 18 is sucked into the compressor 11 and compressed again.

Meanwhile, the refrigerant that flows out from the outside heat exchanger 14 toward the refrigeration expansion valve 22 side flows into the refrigeration expansion valve 22 and is decompressed and expanded. Then, in the battery evaporator 24, this refrigerant absorbs heat from the cooling air to be blown to the secondary battery 65 by the battery evaporator 24, and evaporates. As a result, the cooling air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, in the case where battery cooling is performed during the cooling mode, a refrigerant circuit is formed in which the refrigerant which is heat dissipated by the outside heat exchanger 14 is then evaporated in the air conditioning evaporator 16 and the battery evaporator 24. For this reason, when battery cooling is performed during the cooling mode, air cooled by the air conditioning evaporator 16 is blown into the passenger compartment while air cooled by the battery evaporator 24 is blown to the secondary battery 65. Accordingly, it is possible to cool the passenger compartment and also perform battery cooling which cools the secondary battery 65.

(C) Heating Mode

Next, the operation of the refrigeration cycle device 10 when battery cooling is not performed during the heating mode will be described. In this heating mode, as shown in FIG. 4, the control device 70 controls the first passage opening/closing valve 21, the second passage opening/closing valve 27, and the battery opening/closing valve 23 to be in the closed state, and controls the bypass passage opening/closing valve 30 to be in the open state. In addition, the control device 70 controls the heating expansion valve 13 to be in a throttling state, and controls the cooling expansion valve 15 to be in a fully closed state.

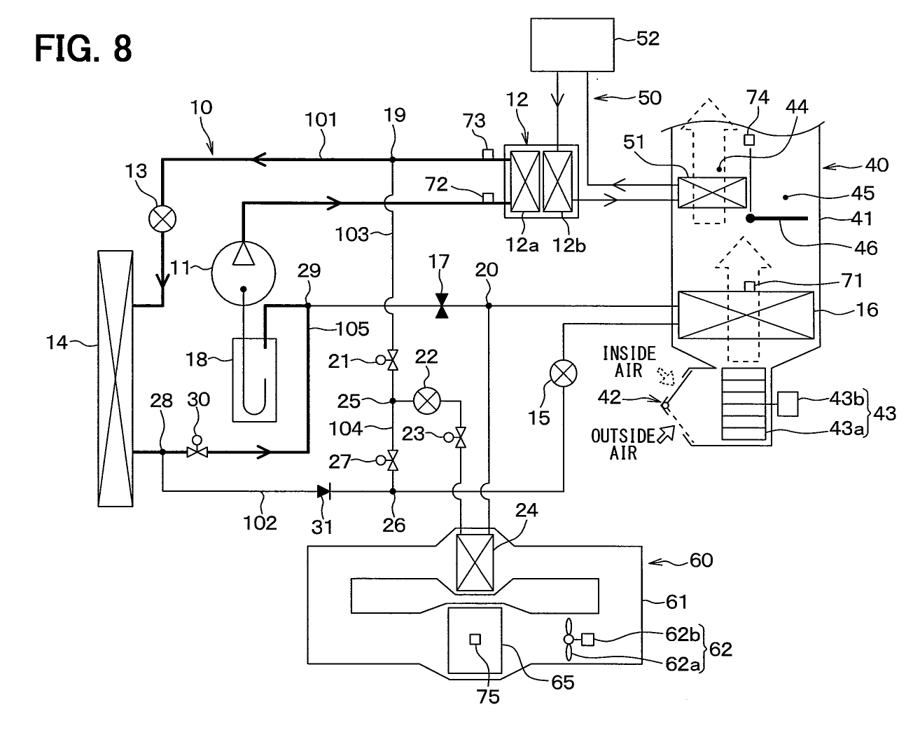

As a result, in the refrigeration cycle device 10, the refrigerant circuit in the cycle becomes a circuit in which the refrigerant flows as indicated by the black thick line with arrows in FIG. 8. In this refrigerant circuit, the control device 70 determines the operation states (e.g. control signals) of the various control equipment connected to the output side of the control device 70.

The control device 70 may control the compressor 11 such that, for example, the blowout air temperature TAV approaches the target blowout temperature TAO through feedback control or the like. Further, regarding the control signal to be output to the heating expansion valve 13, the control device 70 determines the control signal such that the supercooling degree of the refrigerant flowing into the heating expansion valve 13 approaches a target supercooling degree at which the coefficient of performance (i.e., COP) of the cycle substantially reaches a maximum value. Further, the control device 70 controls the air mix door 46 to a position of closing the cool air bypass passage 45. It should be noted that the control device 70 may control the air mix door 46 such that the blowout air temperature TAV approaches the target blowout temperature TAO through feedback control or the like. Further, the control signals to be outputted to the other control equipment are determined in the same manner as in the previously described cooling mode.

The control device 70 outputs the control signals determined as described above to the various control equipment. As a result, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51.

Here, the cooling water which is heated in the water-refrigerant heat exchanger 12 flows into the heater core 51. During the heating mode, since the cool air bypass passage 45 is closed by the air mix door 46, the air in the air conditioning case 41 is heated by the heater core 51 and then blown out into the passenger compartment. Therefore, during the heating mode of the present embodiment, the ventilation air to be blown into the passenger compartment is heated by utilizing the heat of the refrigerant flowing through the water-refrigerant heat exchanger 12.

The refrigerant flowing out of the water-refrigerant heat exchanger 12 flows into the heating expansion valve 13 and is decompressed and expanded. Then, the low pressure refrigerant decompressed and expanded by the heating expansion valve 13 flows into the outside heat exchanger 14. Further, during the heating mode, since the first passage opening/closing valve 21 is in the closed state, no refrigerant flows through the third refrigerant passage 103.

The refrigerant that flows into the outside heat exchanger 14 absorbs heat from the outside air and evaporates. The refrigerant flowing out from the outside heat exchanger 14 enters the accumulator 18 via the bypass passage 105 because the cooling expansion valve 15 is fully closed and the bypass passage opening/closing valve 30 is open. Then, the gas-phase refrigerant separated by the accumulator 18 is sucked into the compressor 11 and compressed again.

As described above, in the case where battery cooling is not performed during the heating mode, a refrigerant circuit is formed in which the refrigerant which is heat dissipated in the water-refrigerant heat exchanger 12 is then evaporated in the outside heat exchanger 14. For this reason, in the case where battery cooling is not performed during the heating mode, air is heated by utilizing the heat of the refrigerant flowing in the water-refrigerant heat exchanger 12 and then blown into the passenger compartment. Accordingly, heating of the passenger compartment can be performed.

(D) Heating Mode+Battery Cooling

Next, the operation of the refrigeration cycle device 10 when battery cooling is performed during the heating mode will be described. In this heating mode, as shown in FIG. 5, the control device 70 controls the second passage opening/closing valve 27 to be in the closed state, and controls the first passage opening/closing valve 21, the bypass passage opening/closing valve 30, and the battery opening/closing valve 23 to be in the open state. In addition, the control device 70 controls the heating expansion valve 13 and the refrigeration expansion valve 22 to be in a throttling state, and controls the cooling expansion valve 15 so as to be in a fully closed state.

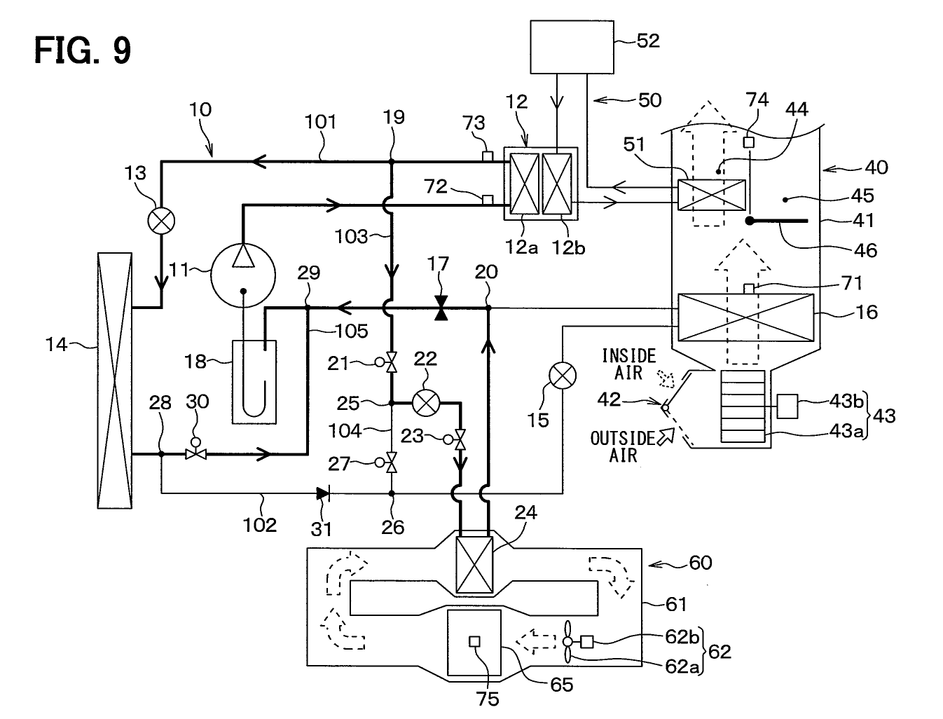

As a result, in the refrigeration cycle device 10, the refrigerant circuit in the cycle becomes a circuit in which the refrigerant flows as indicated by the black thick line with arrows in FIG. 9. In this refrigerant circuit, the control device 70 determines the operation states (e.g. control signals) of the various control equipment connected to the output side of the control device 70.

Regarding the control signal to be output to the refrigeration expansion valve 22, the control device 70 may, for example, determine the control signal such that the flow rate of the refrigerant flowing into the battery evaporator 24 increases when the battery temperature Tb of the secondary battery 65 is high. In other words, the control device 70 controls the throttle opening degree of the refrigeration expansion valve 22 to increase as the battery temperature Tb of the secondary battery 65 increases.

Further, regarding the control signal to be output to the battery blower 62, the control device 70 determines the control signal such that the amount of air blown to the secondary battery 65 is a predetermined air volume that is determined in advance. Further, the control signals to be outputted to the other control equipment are determined in the same manner as in the previously described heating mode.

The control device 70 outputs the control signals determined as described above to the various control equipment. As a result, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out from water-refrigerant heat exchanger 12 will then flow into both the heating expansion valve 13 and the refrigeration expansion valve 22 because the second passage opening/closing valve 27 is in the closed state while both the first passage opening/closing valve 21 and the battery opening/closing valve 23 are in the open state.

The refrigerant flowing from the water-refrigerant heat exchanger 12 toward the heating expansion valve 13 flows into the heating expansion valve 13 and is decompressed and expanded. Then, this refrigerant absorbs heat from the outside air in the outside heat exchanger 14 and evaporates. After that, the refrigerant flowing out from the outside heat exchanger 14 enters the accumulator 18 via the bypass passage 105 because the cooling expansion valve 15 is fully closed and the bypass passage opening/closing valve 30 is open. Then, the gas-phase refrigerant separated by the accumulator 18 is sucked into the compressor 11 and compressed again.

Meanwhile, the refrigerant that flows out from the water-refrigerant heat exchanger 12 toward the refrigeration expansion valve 22 flows into the refrigeration expansion valve 22 and is decompressed and expanded. Then, in the battery evaporator 24, this refrigerant absorbs heat from the cooling air to be blown to the secondary battery 65 by the battery evaporator 24, and evaporates. As a result, the cooling air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, in the case where battery cooling is performed during the heating mode, a refrigerant circuit is formed in which the refrigerant which is heat dissipated by the water-refrigerant heat exchanger 12 is then evaporated in the outside heat exchanger 14 and the battery evaporator 24. For this reason, when battery cooling is performed during the heating mode, air heated using heat from the refrigerant flowing in the water-refrigerant heat exchanger 12 is blown into the passenger compartment while air cooled by the battery evaporator 24 is blown to the secondary battery 65. Accordingly, it is possible to heat the passenger compartment and also perform battery cooling.

(E) Series Dehumidifying Heating Mode

Next, the operation of the refrigeration cycle device 10 when battery cooling is not performed during the series dehumidifying heating mode will be described. In this series dehumidifying heating mode, as shown in FIG. 4, the control device 70 controls the respective opening/closing valves 21, 23, 27, 30 to be closed.

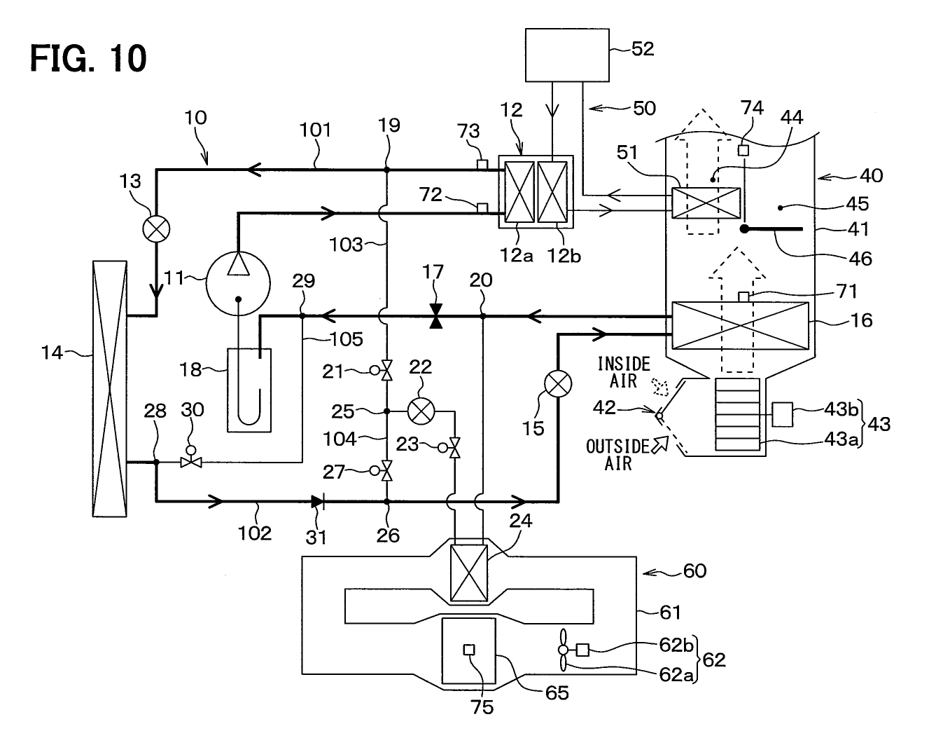

As a result, in the refrigeration cycle device 10, the refrigerant circuit in the cycle becomes a circuit in which the refrigerant flows as indicated by the black thick line with arrows in FIG. 10. That is, during the series dehumidifying heating mode, as shown in FIG. 10, a refrigerant circuit is formed in which the outside heat exchanger 14 and the air conditioning evaporator 16 are connected in series with respect to the refrigerant flow. In this refrigerant circuit, the control device 70 determines the operation states (e.g. control signals) of the various control equipment connected to the output side of the control device 70.

The control device 70, for example, controls the air mix door 46 to a position of closing the cool air bypass passage 45. It should be noted that the control device 70 may control the air mix door 46 such that the blowout air temperature TAV approaches the target blowout temperature TAO through feedback control or the like.

Further, regarding the heating expansion valve 13 and the cooling expansion valve 15, the control device 70 determines these control signals according to the target blowout temperature TAO. In the present embodiment, as the target blowout temperature TAO increases, the control device 70 controls the throttle opening degree of the heating expansion valve 13 to decrease and also controls the throttle opening degree of the cooling expansion valve 15 to increase.

For example, when the target blowout temperature TAO is equal to or higher than a predetermined determination reference temperature, the control device 70 of the present embodiment controls the heating expansion valve 13 and the cooling expansion valve 15 such that the outside heat exchanger 14 functions as a radiator. Further, when the target blowout temperature TAO is less than the determination reference temperature, the control device 70 of the present embodiment controls the heating expansion valve 13 and the cooling expansion valve 15 such that the outside heat exchanger 14 functions as a heat absorber. Further, the control signals to be outputted to the other control equipment are determined in the same manner as in the previously described heating mode.

The control device 70 outputs the control signals determined as described above to the various control equipment. In the present embodiment, regarding the series dehumidifying and heating mode, the state of the refrigerant flowing in the refrigerant circuit will be explained for a first mode and a second mode. In the first mode, the outside heat exchanger 14 functions as a radiator. In the second mode, the outside heat exchanger 14 functions as a heat absorber.

(E-1) First Mode

During the first mode of the series dehumidifying heating mode, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out of the water-refrigerant heat exchanger 12 is either decompressed and expanded by the heating expansion valve 13, or is mostly not decompressed and expanded by the heating expansion valve 13, and then flows into the outside heat exchanger 14. Further, during the present operation mode, since the first passage opening/closing valve 21 is in the closed state, no refrigerant flows through the third refrigerant passage 103.

The refrigerant that flows into the outside heat exchanger 14 exchanges heat with the outside air to dissipate heat. Then, the refrigerant that flows out of the outside heat exchanger 14 will flow into the cooling expansion valve 15 via the check valve 31 to be decompressed and expanded. Further, during the present operation mode, since the bypass passage opening/closing valve 30 and the second passage opening/closing valve 27 are in the closed state, no refrigerant flows through the fourth refrigerant passage 104 or the bypass passage 105.

The refrigerant flows out from the cooling expansion valve 15, and then flows into the air conditioning evaporator 16. The refrigerant absorbs heat from air that has yet to pass through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

As described above, in the first mode of the series dehumidifying heating mode, a refrigerant circuit is formed in which the refrigerant is heat dissipated by both the water-refrigerant heat exchanger 12 and the outside heat exchanger 14, and is then evaporated in the air conditioning evaporator 16. During the first mode of the series dehumidifying heating mode, after being dehumidified by the air conditioning evaporator 16, air is heated by utilizing the heat of the refrigerant flowing in the water-refrigerant heat exchanger 12. Then, the air is blown into the passenger compartment. Accordingly, dehumidifying heating of the passenger compartment may be performed.

Here, in the first mode of the series dehumidifying heating mode, the outside heat exchanger 14 functions as a radiator. Therefore, during the first mode of the series dehumidifying heating mode, it is possible to reduce the amount of heat dissipated by the refrigerant in the water-refrigerant heat exchanger 12 while ensuring the amount of heat absorbed by the refrigerant in the air conditioning evaporator 16. As a result, during the first mode of the series dehumidifying heating mode, dehumidified, low temperature warm air can be blown into the passenger compartment.

(E-2) Second Mode

During the second mode of the series dehumidifying heating mode, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant flowing out of the water-refrigerant heat exchanger 12 is decompressed and expanded at the heating expansion valve 13. Then, the low pressure refrigerant decompressed and expanded by the heating expansion valve 13 flows into the outside heat exchanger 14. Further, during the present operation mode, since the first passage opening/closing valve 21 is in the closed state, no refrigerant flows through the third refrigerant passage 103.

The refrigerant that flows into the outside heat exchanger 14 exchanges heat with the outside air to absorb heat. Then, the refrigerant that flows out of the outside heat exchanger 14 is either decompressed and expanded by the cooling expansion valve 15, or is mostly not decompressed and expanded by the cooling expansion valve 15, and then flows into the air conditioning evaporator 16. Further, during the present operation mode, since the bypass passage opening/closing valve 30 and the second passage opening/closing valve 27 are in the closed state, no refrigerant flows through the fourth refrigerant passage 104 or the bypass passage 105.

After flowing into the air conditioning evaporator 16, the refrigerant absorbs heat from air that has yet to pass through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

As described above, during the second mode of the series dehumidifying heating mode, a refrigerant circuit is formed in which the refrigerant is heat dissipated by the water-refrigerant heat exchanger 12, and is then evaporated at both the outside heat exchanger 14 and the air conditioning evaporator 16. During the second mode of the series dehumidifying heating mode, after being dehumidified by the air conditioning evaporator 16, air is heated by utilizing the heat of the refrigerant flowing in the water-refrigerant heat exchanger 12. Then, the air is blown into the passenger compartment. Accordingly, dehumidifying heating of the passenger compartment may be performed.

Here, in the second mode of the series dehumidifying heating mode, the outside heat exchanger 14 functions as a heat absorber. Therefore, during the second mode of the series dehumidifying heating mode, it is possible to reduce the amount of heat absorbed by the refrigerant in the air conditioning evaporator 16 while ensuring the amount of heat dissipated by the refrigerant in the water-refrigerant heat exchanger 12. As a result, during the second mode of the series dehumidifying heating mode, dehumidified, high temperature warm air can be blown into the passenger compartment.

(F) Series Dehumidifying Heating Mode+Normal Battery Cooling

Next, the operation of the refrigeration cycle device 10 when normal battery cooling is performed during the series dehumidifying heating mode will be described. In this series dehumidifying heating mode, as shown in FIG. 5, the control device 70 controls the first passage opening/closing valve 21 and the bypass passage opening/closing valve 30 to be in the closed state, and controls the second passage opening/closing valve 27 and the battery opening/closing valve 23 to be in the open state.

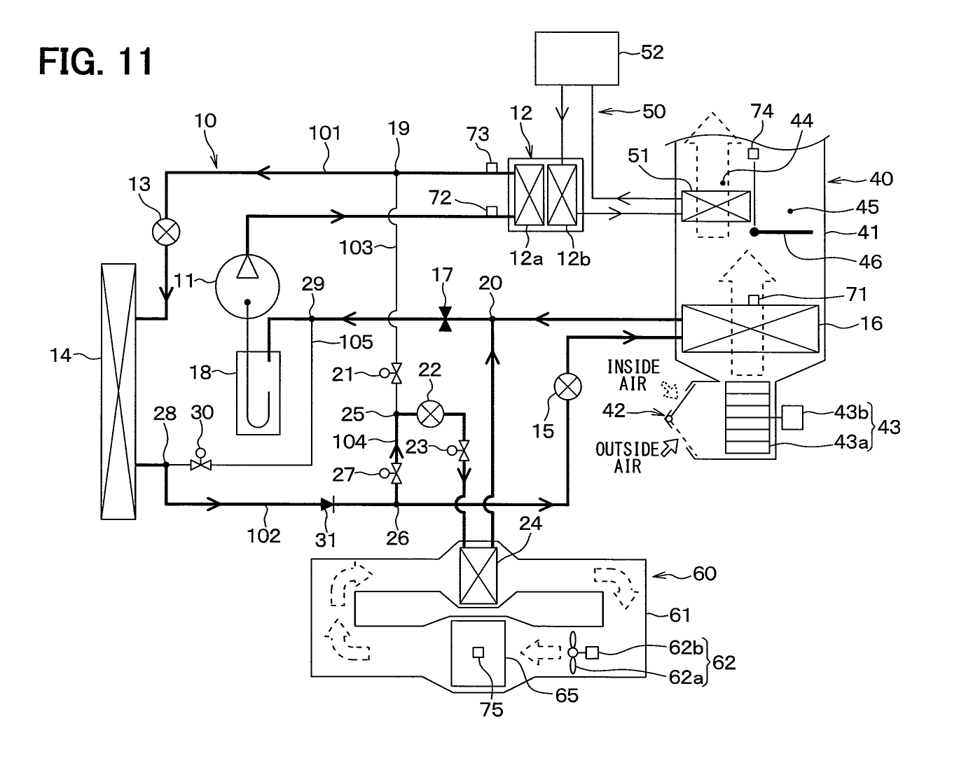

As a result, in the refrigeration cycle device 10, the refrigerant circuit in the cycle becomes a circuit in which the refrigerant flows as indicated by the black thick line with arrows in FIG. 11. In other words, when normal battery cooling is performed during the series dehumidifying heating mode, as shown in FIG. 11, a refrigerant circuit is formed in which the outside heat exchanger 14 and the air conditioning evaporator 16 are connected in series with respect to the refrigerant flow, and in which the air conditioning evaporator 16 and the battery evaporator 24 are connected in parallel with respect to the refrigerant flow.

Due to this, when normal battery cooling is performed during the series dehumidifying heating mode, the refrigerant discharged from the compressor 11 flows, in order, through the water-refrigerant heat exchanger 12, the heating expansion valve 13, and then the outside heat exchanger 14. Thereafter, the refrigerant flowing out of the outside heat exchanger 14 flows through the cooling expansion valve 15 and the air conditioning evaporator 16 in this order, and also flows through the refrigeration expansion valve 22 and the battery evaporator 24 in this order.

In this refrigerant circuit, the control device 70 determines the operation states (e.g. control signals) of the various control equipment connected to the output side of the control device 70.

Regarding the control signal to be output to the refrigeration expansion valve 22, the control device 70 may, for example, determine the control signal such that the flow rate of the refrigerant flowing into the battery evaporator 24 increases when the battery temperature Tb of the secondary battery 65 is high. In other words, the control device 70 controls the throttle opening degree of the refrigeration expansion valve 22 to increase as the battery temperature Tb of the secondary battery 65 increases.

Further, regarding the control signal to be output to the battery blower 62, the control device 70 determines the control signal such that the amount of air blown to the secondary battery 65 is a predetermined air volume that is determined in advance. Further, the control signals to be outputted to the other control equipment are determined in the same manner as in the previously described embodiment in which battery cooling is not performed during the series dehumidifying heating mode.

The control device 70 outputs the control signals determined as described above to the various control equipment. In the present embodiment, regarding the series dehumidifying and heating mode, the state of the refrigerant flowing in the refrigerant circuit will be explained for a first mode and a second mode. In the first mode, the outside heat exchanger 14 functions as a radiator. In the second mode, the outside heat exchanger 14 functions as a heat absorber.

(F-1) First Mode

When normal battery cooling is performed during the first mode of the series dehumidifying heating mode, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out of the water-refrigerant heat exchanger 12 is either decompressed and expanded by the heating expansion valve 13, or is mostly not decompressed and expanded by the heating expansion valve 13, and then flows into the outside heat exchanger 14. Further, during the present operation mode, since the first passage opening/closing valve 21 is in the closed state, no refrigerant flows through the third refrigerant passage 103.

The refrigerant that flows into the outside heat exchanger 14 exchanges heat with the outside air to dissipate heat. The refrigerant that flows out from the outside heat exchanger 14 will then flow into both the cooling expansion valve 15 and the refrigeration expansion valve 22 because both the second passage opening/closing valve 27 and the battery opening/closing valve 23 are in the open state.

The refrigerant that flows from the outside heat exchanger 14 toward the cooling expansion valve 15 flows into the cooling expansion valve 15 and is decompressed and expanded. Then, this refrigerant flows into the air conditioning evaporator 16, absorbs heat from the air prior to the air passing through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

Meanwhile, the refrigerant that flows out from the outside heat exchanger 14 toward the refrigeration expansion valve 22 side flows into the refrigeration expansion valve 22 and is decompressed and expanded. Then, in the battery evaporator 24, this refrigerant absorbs heat from the air to be blown to the secondary battery 65 by the battery evaporator 24, and evaporates. As a result, the air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, when normal battery cooling is performed during the first mode of the series dehumidifying heating mode, a refrigerant circuit is formed in which the refrigerant is heat dissipated by both the water-refrigerant heat exchanger 12 and the outside heat exchanger 14, and is then evaporated in the air conditioning evaporator 16 and the battery evaporator 24.

For this reason, when battery cooling is performed during the first mode of the series dehumidifying heating mode, after being dehumidified by the air conditioning evaporator 16, air is heated by utilizing the heat of the refrigerant flowing in the water-refrigerant heat exchanger 12. Then, the air is blown into the passenger compartment. Accordingly, dehumidifying heating of the passenger compartment may be performed.

Furthermore, when battery cooling is performed during the first mode of the series dehumidifying heating mode, the secondary battery 65 can be cooled by blowing the air cooled by the battery evaporator 24 to the secondary battery 65.

(F-2) Second Mode

Next, when normal battery cooling is performed during the second mode of the series dehumidifying heating mode, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant flowing out of the water-refrigerant heat exchanger 12 is decompressed and expanded at the heating expansion valve 13. Then, the low pressure refrigerant decompressed by the heating expansion valve 13 flows into the outside heat exchanger 14. Further, during the present operation mode, since the first passage opening/closing valve 21 is in the closed state, no refrigerant flows through the third refrigerant passage 103.

The refrigerant that flows into the outside heat exchanger 14 exchanges heat with the outside air to absorb heat. The refrigerant that flows out from the outside heat exchanger 14 will then flow into both the cooling expansion valve 15 and the refrigeration expansion valve 22 because both the second passage opening/closing valve 27 and the battery opening/closing valve 23 are in the open state.

The refrigerant that flows from the outside heat exchanger 14 toward the cooling expansion valve 15 is either decompressed and expanded by the cooling expansion valve 15, or is mostly not decompressed and expanded by the cooling expansion valve 15. Then, this refrigerant flows into the air conditioning evaporator 16, absorbs heat from the air prior to the air passing through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

Meanwhile, the refrigerant that flows out from the outside heat exchanger 14 toward the refrigeration expansion valve 22 side flows into the refrigeration expansion valve 22 and is decompressed and expanded. Then, in the battery evaporator 24, this refrigerant absorbs heat from the air to be blown to the secondary battery 65 by the battery evaporator 24, and evaporates. As a result, the air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, when normal battery cooling is performed during the second mode of the series dehumidifying heating mode, a refrigerant circuit is formed in which the refrigerant is heat dissipated by the water-refrigerant heat exchanger 12, and is then evaporated in the outside heat exchanger 14, the air conditioning evaporator 16, and the battery evaporator 24.

For this reason, when normal battery cooling is performed during the second mode of the series dehumidifying heating mode, after being dehumidified by the air conditioning evaporator 16, air is heated by utilizing the heat of the refrigerant flowing in the water-refrigerant heat exchanger 12. Then, the air is blown into the passenger compartment. Accordingly, dehumidifying heating of the passenger compartment may be performed. Furthermore, when battery cooling is performed during the second mode of the series dehumidifying heating mode, the secondary battery 65 can be cooled by blowing the air cooled by the battery evaporator 24 to the secondary battery 65.

Here, when normal battery cooling is performed during the second mode of the series dehumidifying heating mode, as the target blowout temperature TAO increases, the throttle opening degree of the heating expansion valve 13 is controlled toward the closing side, and at the same time, the throttle opening degree of the expansion valve 15 is controlled toward the open side. In this case, if the cooling capacity required for the air conditioning evaporator 16 decreases, the cooling expansion valve 15 may be controlled to be fully opened.

At this time, if the battery temperature Tb of the secondary battery 65 is high, both of the cooling expansion valve 15 and the refrigeration expansion valve 22 will be controlled to the fully opened state. In this case, the flow rate ratio of the refrigerant flowing into the each of the evaporators 16, 24 depends on the ratio between the maximum opening areas of the cooling expansion valve 15 and the refrigeration expansion valve 22, and the flow rate of the refrigerant flowing into the battery evaporator 24 cannot be increased.

In this way, when performing normal battery cooling during the second mode of the series dehumidifying heating mode, if the cooling capacity required of the air conditioning evaporator 16 decreases, a situation may arise in which the flow rate of the refrigerant flowing into the battery evaporator 24 cannot be increased, and as a result the cooling capacity of the battery evaporator 24 is insufficient. In other words, when performing normal battery cooling during the second mode of the series dehumidifying heating mode, if the cooling capacity required of the air conditioning evaporator 16 decreases, the cooling capacity of the battery evaporator 24 for the air to be blown to the secondary battery 65 may be insufficient.

In view of this, according to the refrigeration cycle device 10 of the present embodiment, when performing normal battery cooling during the second mode of the series dehumidifying heating mode, if the condition that the flow rate of refrigerant into the battery evaporator 24 is insufficient is satisfied, then priority battery cooling which prioritizes the cooling of the secondary battery 65 is performed.

According to the refrigeration cycle device 10, the situation in which the cooling capacity of the battery evaporator 24 is insufficient arises when, during an operation mode in which the outside heat exchanger 14 is functioning as a heat absorber, the cooling expansion valve 15 is in the fully open state. Therefore, in the present embodiment, when the cooling expansion valve 15 is in the fully open state during an operation mode in which the outside heat exchanger 14 functions as a heat absorber, the condition that the flow rate of the refrigerant flowing into the battery evaporator 24 is insufficient is assumed to be satisfied.

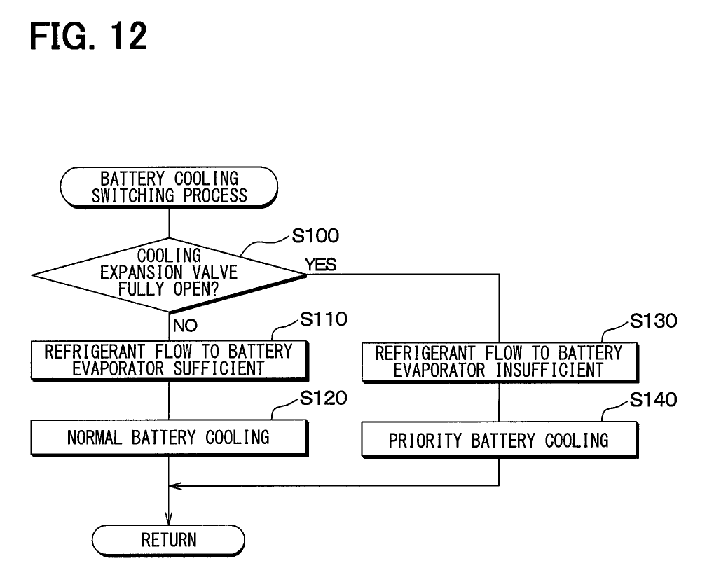

The control device 70 executes the control programs stored in the storage unit to switch between normal battery cooling and priority battery cooling during the series dehumidifying heating mode. The switching process between normal battery cooling and priority battery cooling, which is executed by the control device 70 of the present embodiment, will be described with reference to the flowchart of FIG. 12. FIG. 12 is a flowchart showing the flow of a battery cooling switching process executed by the control device 70. Each of the control steps shown in FIG. 12 constitutes a functional unit for implementing various functions and is executed by the control device 70.

When the operation mode of the refrigeration cycle device 10 is determined to be the series dehumidifying heating mode, as shown in FIG. 12, the control device 70 determines in step S100 whether or not the cooling expansion valve 15 is in the fully open state.

When this result is that the cooling expansion valve 15 is determined to not be in the fully open state, the control device 70 determines in step S110 that the flow rate of the refrigerant flowing into the battery evaporator 24 is sufficient. In other words, when it is determined that the cooling expansion valve 15 is not in the fully open state, the control device 70 determines that the condition that the flow rate of the refrigerant flowing into the battery evaporator 24 is insufficient is not satisfied. Then, in step S120, the control device 70 determines the battery cooling during the series dehumidifying heating mode to be the normal battery cooling as described previously.

Conversely, at step S110, when it is determined that the cooling expansion valve 15 is in the fully open state, the control device 70 determines in step S130 that the flow rate of the refrigerant flowing into the battery evaporator 24 is insufficient. In other words, when it is determined that the cooling expansion valve 15 is in the fully open state, the control device 70 determines that the condition that the flow rate of the refrigerant flowing into the battery evaporator 24 is insufficient is satisfied. Then, in step S140, the control device 70 determines the battery cooling during the series dehumidifying heating mode to be the priority battery cooling that prioritizes the cooling of the secondary battery 65.

(G) Series Dehumidifying Heating Mode+Priority Battery Cooling

Hereinafter, the operation of the refrigeration cycle device 10 when priority battery cooling is performed during the series dehumidifying heating mode will be described. In this series dehumidifying heating mode, as shown in FIG. 5, the control device 70 controls the second passage opening/closing valve 27 and the bypass passage opening/closing valve 30 to be in the closed state, and controls the first passage opening/closing valve 21 and the battery opening/closing valve 23 to be in the open state. In addition, the control device 70 controls the throttle opening degree of the cooling expansion valve 15 to be in a fully opened state, and controls the heating expansion valve 13 and the refrigeration expansion valve 22 so as to be in a throttling state.

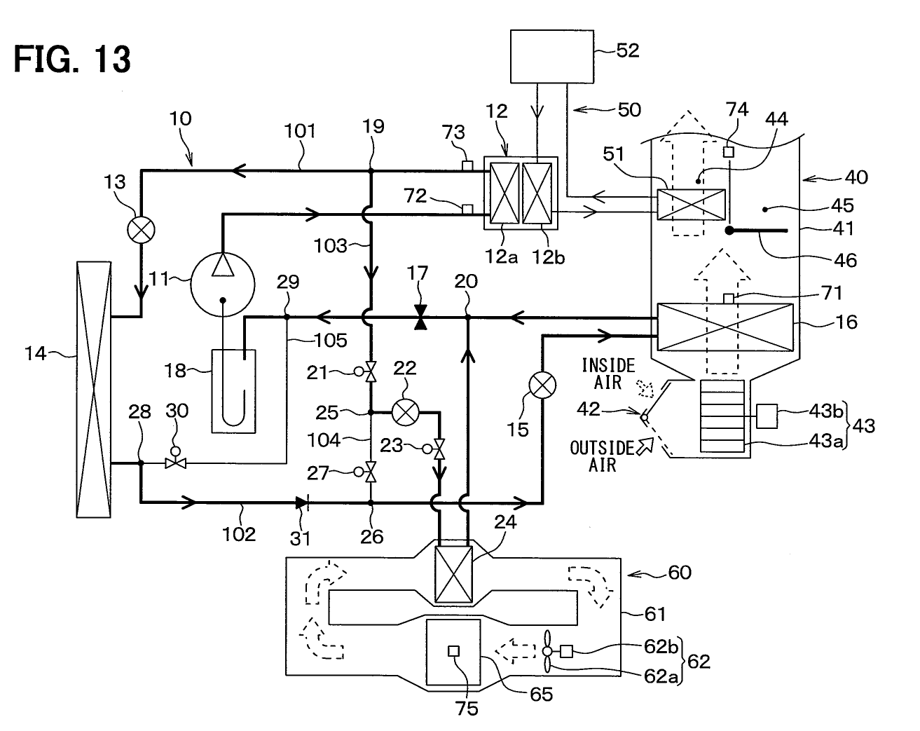

As a result, in the refrigeration cycle device 10, the refrigerant circuit in the cycle becomes a circuit in which the refrigerant flows as indicated by the black thick line with arrows in FIG. 13. In other words, when priority battery cooling is performed during the series dehumidifying heating mode, as shown in FIG. 13, a refrigerant circuit is formed in which the outside heat exchanger 14 and the air conditioning evaporator 16 are connected in series with respect to the refrigerant flow. Furthermore, when priority battery cooling is performed during the series dehumidifying heating mode, a refrigerant circuit is formed in which the battery evaporator 24 is connected in parallel with respect to the series connected outside heat exchanger 14 and air conditioning evaporator 16.

Due to this, when priority battery cooling is performed during the series dehumidifying heating mode, the refrigerant discharged from the compressor 11 flows to the water-refrigerant heat exchanger 12. Thereafter, the refrigerant flowing out of the water-refrigerant heat exchanger 12 flows through the heating expansion valve 13, the outside heat exchanger 14, the cooling expansion valve 15, and the air conditioning evaporator 16 in this order, and also flows through the refrigeration expansion valve 22 and the battery evaporator 24 in this order.

In this refrigerant circuit, the control device 70 determines the operation states (e.g. control signals) of the various control equipment connected to the output side of the control device 70.

Regarding the control signals to be output to the heating expansion valve 13 and the refrigeration expansion valve 22, the control device 70 may, for example, determine the control signals such that the flow rate of the refrigerant flowing into the battery evaporator 24 increases when the battery temperature Tb of the secondary battery 65 is high. In other words, as the battery temperature Tb of the secondary battery 65 increases, the control device 70 controls the throttle opening degree of the refrigeration expansion valve 22 to increase, and controls the throttle opening degree of the heating expansion valve 13 to decrease.

Further, regarding the control signal to be output to the battery blower 62, the control device 70 determines the control signal such that the amount of air blown to the secondary battery 65 is a predetermined air volume that is determined in advance. The control signals to be outputted to the other control equipment are determined in the same manner as in the previously described embodiment in which normal battery cooling is performed during the series dehumidifying heating mode.

The control device 70 outputs the control signals determined as described above to the various control equipment. As a result, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out from water-refrigerant heat exchanger 12 will then flow into both the heating expansion valve 13 and the refrigeration expansion valve 22 because both the first passage opening/closing valve 21 and the battery opening/closing valve 23 are in the open state, while the second passage opening/closing valve 27 is in the closed state.

The refrigerant that flowed from the water-refrigerant heat exchanger 12 to the heating expansion valve 13 is decompressed and expanded at the heating expansion valve 13, and then flows into the outside heat exchanger 14. The refrigerant that flows into the outside heat exchanger 14 exchanges heat with the outside air to absorb heat. The refrigerant that flows out from the outside heat exchanger 14 will then flow toward the cooling expansion valve 15 because the bypass passage opening/closing valve 30 and the second passage opening/closing valve 27 are in the closed state.

Since the cooling expansion valve 15 is in the fully open state, the refrigerant that flows out of the outside heat exchanger 14 toward the cooling expansion valve 15 will flow into the air conditioning evaporator 16 substantially without being decompressed and expanded by the cooling expansion valve 15. Then, after flowing into the air conditioning evaporator 16, the refrigerant absorbs heat from air that has yet to pass through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

Meanwhile, the refrigerant that flows out from the water-refrigerant heat exchanger 12 toward the refrigeration expansion valve 22 flows into the refrigeration expansion valve 22 and is decompressed and expanded. Then, in the battery evaporator 24, this refrigerant absorbs heat from the air to be blown to the secondary battery 65 by the battery evaporator 24, and evaporates. As a result, the air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, when priority battery cooling is performed during the series dehumidifying heating mode, a refrigerant circuit is formed in which the refrigerant is heat dissipated by the water-refrigerant heat exchanger 12, and is then evaporated in the outside heat exchanger 14, the air conditioning evaporator 16, and the battery evaporator 24.

For this reason, when priority battery cooling is performed during the series dehumidifying heating mode, after being dehumidified by the air conditioning evaporator 16, air is heated by utilizing the heat of the refrigerant flowing in the water-refrigerant heat exchanger 12. Then, the air is blown into the passenger compartment. Accordingly, dehumidifying heating of the passenger compartment may be performed. Furthermore, when priority battery cooling is performed during the series dehumidifying heating mode, the secondary battery 65 can be cooled by blowing the air cooled by the battery evaporator 24 to the secondary battery 65.

Here, according to the refrigeration cycle device 10 of the present embodiment, when priority battery cooling is performed during the series dehumidifying heating mode, a refrigerant circuit is formed in which the battery evaporator 24 is connected in parallel with respect to the series connected outside heat exchanger 14 and air conditioning evaporator 16.

In this refrigerant circuit, even if the throttle opening degrees of both the cooling expansion valve 15 and the refrigeration expansion valve 22 are fully open, the flow rate of the refrigerant flowing into the battery evaporator 24 can be increased by reducing the throttle opening degree of the heating expansion valve 13.

Accordingly, when performing priority battery cooling during the series dehumidifying heating mode, even if the cooling capacity required of the air conditioning evaporator 16 decreases, by increasing the flow rate of the refrigerant flowing into the battery evaporator 24, it is possible for the battery evaporator 24 to provide an appropriate level of cooling capacity.

(H) Parallel Dehumidifying Heating Mode

Next, the operation of the refrigeration cycle device 10 when battery cooling is not performed during the parallel dehumidifying heating mode will be described. In this parallel dehumidifying heating mode, as shown in FIG. 4, the control device 70 controls the first passage opening/closing valve 21, the second passage opening/closing valve 27, and the bypass passage opening/closing valve 30 to be in the open state, and controls the battery opening/closing valve 23 to be in the closed state. In addition, the control device 70 controls both the heating expansion valve 13 and the cooling expansion valve 15 to be in a throttling state.

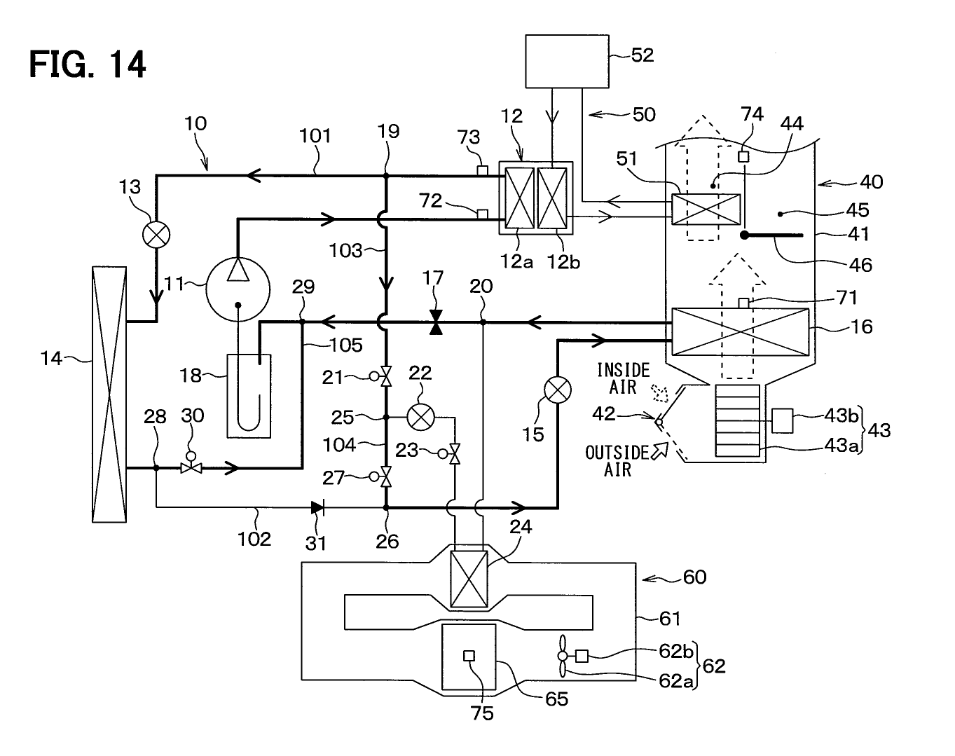

As a result, in the refrigeration cycle device 10, the refrigerant circuit in the cycle becomes a circuit in which the refrigerant flows as indicated by the black thick line with arrows in FIG. 14. That is, during the parallel dehumidifying heating mode, as shown in FIG. 14, a refrigerant circuit is formed in which the outside heat exchanger 14 and the air conditioning evaporator 16 are connected in parallel with respect to the refrigerant flow. In this refrigerant circuit, the control device 70 determines the operation states (e.g. control signals) of the various control equipment connected to the output side of the control device 70.

For example, the control device 70 may determine the throttle opening degrees of the heating expansion valve 13 and the cooling expansion valve 15 to be predetermined opening degrees. The control signals to be outputted to the other control equipment are determined in the same manner as in the previously described series dehumidifying heating mode.

The control device 70 outputs the control signals determined as described above to the various control equipment. As a result, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out from water-refrigerant heat exchanger 12 will then flow into both the heating expansion valve 13 and the cooling expansion valve 15 because both the first passage opening/closing valve 21 and the second passage opening/closing valve 27 are in the open state, while the battery opening/closing valve 23 is in the closed state.

Here, the check valve 31 is provided in the second refrigerant passage 102. Therefore, the refrigerant flowing through the fourth refrigerant passage 104 does not flow into the bypass passage 105 via the second refrigerant passage 102.

The refrigerant that flowed from the water-refrigerant heat exchanger 12 to the heating expansion valve 13 is decompressed and expanded at the heating expansion valve 13, and then flows into the outside heat exchanger 14. The refrigerant that flows into the outside heat exchanger 14 exchanges heat with the outside air to absorb heat. After that, the refrigerant flowing out from the outside heat exchanger 14 enters the accumulator 18 via the bypass passage 105 because the bypass passage opening/closing valve 30 is open, and is gas-liquid separated. Then, the gas-phase refrigerant separated by the accumulator 18 is sucked into the compressor 11 and compressed again.

Meanwhile, the refrigerant that flowed from the water-refrigerant heat exchanger 12 to the cooling expansion valve 15 is decompressed and expanded at the cooling expansion valve 15, and then flows into the air conditioning evaporator 16. Then, after flowing into the air conditioning evaporator 16, the refrigerant absorbs heat from air that has yet to pass through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

As described above, when battery cooling is not performed during the parallel dehumidifying heating mode, a refrigerant circuit is formed in which the refrigerant is heat dissipated by the water-refrigerant heat exchanger 12, and is then evaporated in the outside heat exchanger 14 and the air conditioning evaporator 16.

In this refrigerant circuit, by adjusting the throttle opening degrees of each expansion valve 13, 15, it is possible to change the flow rate ratio between refrigerant flowing into the outside heat exchanger 14 and the air conditioning evaporator 16. That is, in this configuration, by adjusting the throttle opening degrees of each expansion valve 13, 15, it is possible to adjust the heat absorption amount in the outside heat exchanger 14 and the heat absorption amount in the air conditioning evaporator 16.

Here, during the parallel dehumidifying heating mode, unlike during the series dehumidifying heating mode, a refrigerant circuit is provided in which the outside heat exchanger 14 and the air conditioning evaporator 16 are connected in parallel with respect to the refrigerant flow. As compared with the case of the series dehumidifying heating mode, the flow rate of the refrigerant flowing into the air conditioning evaporator 16 is lower. Therefore, during the parallel dehumidifying heating mode, as compared with the series dehumidifying heating mode, after air is dehumidified at the air conditioning evaporator 16, it is possible to adjust the temperature of that air in a high temperature range at the heater core 51.

(I) Parallel Dehumidifying Heating Mode+Battery Cooling

Next, the operation of the refrigeration cycle device 10 when battery cooling is performed during the parallel dehumidifying heating mode will be described. In this parallel dehumidifying heating mode, as shown in FIG. 5, the control device 70 controls the respective opening/closing valves 21, 23, 27, 30 to be open. In addition, the control device 70 controls each of the heating expansion valve 13, the cooling expansion valve 15, and the refrigeration expansion valve 22 to be in a throttling state.

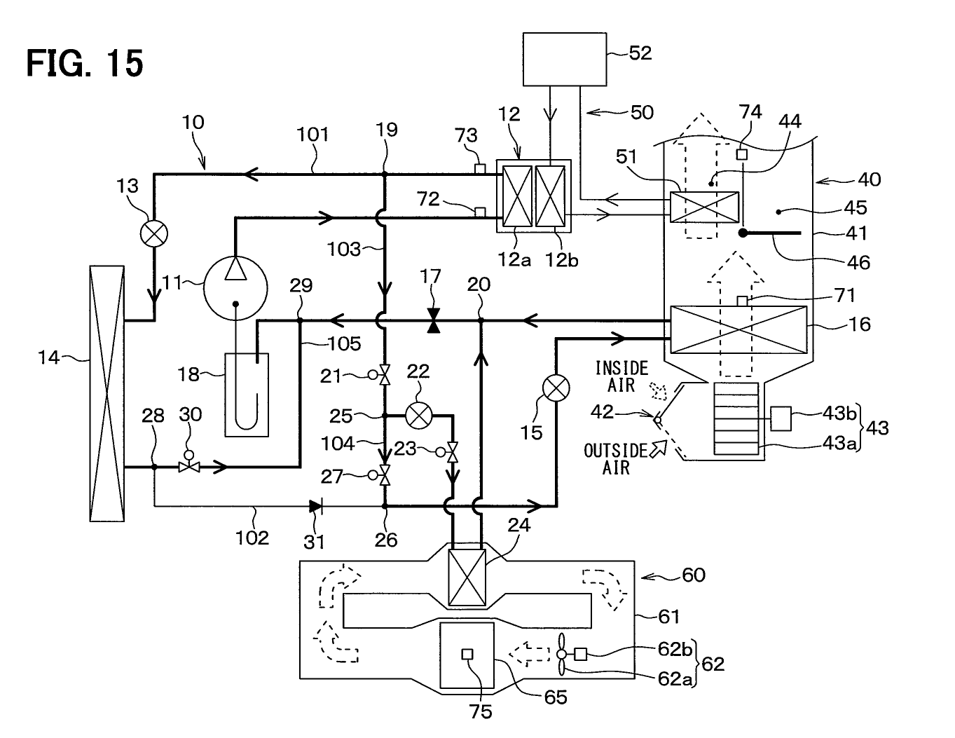

As a result, in the refrigeration cycle device 10, the refrigerant circuit in the cycle becomes a circuit in which the refrigerant flows as indicated by the black thick line with arrows in FIG. 15. That is, during the parallel dehumidifying heating mode, as shown in FIG. 15, a refrigerant circuit is formed in which the outside heat exchanger 14, the air conditioning evaporator 16, and the battery evaporator 24 are connected in parallel with respect to the refrigerant flow. In this refrigerant circuit, the control device 70 determines the operation states (e.g. control signals) of the various control equipment connected to the output side of the control device 70.

For example, the control device 70 may determine a predetermined opening degree for each of the expansion valves 13, 15, 22. The control signals to be outputted to the other control equipment are determined in the same manner as in the previously described series dehumidifying heating mode.

The control device 70 outputs the control signals determined as described above to the various control equipment. As a result, the refrigerant discharged from the compressor 11 flows into the refrigerant side passage 12a of the water-refrigerant heat exchanger 12. The refrigerant that flows into the water-refrigerant heat exchanger 12 exchanges heat with the cooling water and radiates heat prior to the cooling water flowing into the heater core 51. Further, the cooling water which is heated in the water-refrigerant heat exchanger 12 flows into the heater core 51. As a result, the ventilation air flowing in the air conditioning case 41 is heated by heat exchange with the cooling water flowing through the heater core 51, and then blown out into the passenger compartment.

The refrigerant that flows out from water-refrigerant heat exchanger 12 will then flow into each of the heating expansion valve 13, the cooling expansion valve 15, and the refrigeration expansion valve 22 because each of the first passage opening/closing valve 21, the second passage opening/closing valve 27, and the battery opening/closing valve 23 are in the open state. Further, the check valve 31 is provided in the second refrigerant passage 102, so refrigerant is unable to flow from the fourth refrigerant passage 104 to the bypass passage 105 via the second refrigerant passage 102.

The refrigerant that flowed from the water-refrigerant heat exchanger 12 to the heating expansion valve 13 is decompressed and expanded at the heating expansion valve 13, and then flows into the outside heat exchanger 14. The refrigerant that flows into the outside heat exchanger 14 exchanges heat with the outside air to absorb heat. After that, the refrigerant flowing out from the outside heat exchanger 14 enters the accumulator 18 via the bypass passage 105 because the bypass passage opening/closing valve 30 is open, and is gas-liquid separated. Then, the gas-phase refrigerant separated by the accumulator 18 is sucked into the compressor 11 and compressed again.

Further, the refrigerant that flowed from the water-refrigerant heat exchanger 12 to the cooling expansion valve 15 is decompressed and expanded at the cooling expansion valve 15, and then flows into the air conditioning evaporator 16. Then, after flowing into the air conditioning evaporator 16, the refrigerant absorbs heat from air that has yet to pass through the heater core 51, and evaporates. As a result, the air is dehumidified by the air conditioning evaporator 16 and then flows into the heater core 51.

The refrigerant flowing out from the air conditioning evaporator 16 then flows into the accumulator 18 via the pressure regulating valve 17, and is separated into gas and liquid. Then, the gas-phase refrigerant separated by the accumulator 18 is sucked into the compressor 11 and compressed again.

In addition, the refrigerant that flowed from the water-refrigerant heat exchanger 12 to the refrigeration expansion valve 22 is decompressed at the refrigeration expansion valve 22, and then flows into the battery evaporator 24. Then, the refrigerant that flowed into the battery evaporator 24 absorbs heat from the air to be blown to the secondary battery 65 in the battery evaporator 24 and evaporates. As a result, the air to be blown to the secondary battery 65 is cooled.

The refrigerant flowing out from the battery evaporator 24 then flows into the accumulator 18 via the pressure regulating valve 17. Then, the gas-phase refrigerant separated by the accumulator 18 is sucked into the compressor 11 and compressed again.

As described above, when battery cooling is performed during the parallel dehumidifying heating mode, a refrigerant circuit is formed in which the refrigerant is heat dissipated by the water-refrigerant heat exchanger 12, and is then evaporated in the outside heat exchanger 14, the air conditioning evaporator 16, and the battery evaporator 24.

In this refrigerant circuit, by changing the flow rate ratio between the refrigerant flowing into the outside heat exchanger 14 and the respective evaporators 16, 24 using the respective expansion valves 13, 15, 22, it is possible to appropriately adjust the amount of heat absorbed by the refrigerant in the outside heat exchanger 14 and the respective evaporators 16, 24.

The refrigeration cycle device 10 of the present embodiment as described above is configured to switch the refrigerant circuit in accordance with the air conditioning operation mode in the passenger compartment and the necessity of battery cooling. Accordingly, it is possible to achieve both comfortable air conditioning in the passenger compartment and cooling of the secondary battery 65 which is a heat generating device.

According to the refrigeration cycle device 10, it is possible to set a refrigerant circuit in which the refrigerant that flowed from the compressor 11 into the water-refrigerant heat exchanger 12 will then flow, in order, through the heating expansion valve 13, the outside heat exchanger 14, the cooling expansion valve 15, and the air conditioning evaporator 16, and also flow, in order, through the refrigeration expansion valve 22 cooling and the battery evaporator 24. In this refrigerant circuit, even if the throttle opening degree of the cooling expansion valve 15 is fully open, the flow rate of the refrigerant flowing into the battery evaporator 24 can be increased by reducing the throttle opening degree of the heating expansion valve 13.

In this regard, according to the refrigeration cycle device 10 of the present embodiment, even if the cooling capacity required of the air conditioning evaporator 16 decreases, by increasing the flow rate of the refrigerant flowing into the battery evaporator 24, it is possible for the battery evaporator 24 to provide cooling capacity.

In particular, in the case of performing battery cooling during the dehumidifying heating mode in which the outside heat exchanger 14 functions as a heat absorber, the refrigeration cycle apparatus 10 of the present embodiment is configured to switch the refrigerant circuit according to whether or not a flow rate insufficient condition, in which the flow rate of refrigerant flowing into the battery evaporator 24 is insufficient, is satisfied.

Specifically, when the flow rate insufficient condition of the refrigerant flowing into the battery evaporator 24 is not satisfied, the refrigeration cycle device 10 of the present embodiment is configured to switch to a refrigerant circuit in which the battery evaporator 24 is connected in parallel to the air conditioning evaporator 16. This refrigerant circuit is a first refrigerant circuit in which the refrigerant discharged from the compressor 11 flows, in order, through the water-refrigerant heat exchanger 12, the heating expansion valve 13, and the outside heat exchanger 14. Then, the refrigerant flows, in order, through the cooling expansion valve 15 and the air conditioning evaporator 16, and also flows, in order, through the refrigeration expansion valve 22 cooling and the battery evaporator 24.

Further, when the flow rate insufficient condition of the refrigerant flowing into the battery evaporator 24 is satisfied, the refrigeration cycle device 10 of the present embodiment is configured to switch to a refrigerant circuit in which the outside heat exchanger 14 is connected in series with the air conditioning evaporator 16, and the battery evaporator 24 is connected in parallel with respect to the series-connected outside heat exchanger 14 and air conditioning evaporator 16. This refrigerant circuit is a second refrigerant circuit in which the refrigerant discharged from the compressor 11 flows to the water-refrigerant heat exchanger 12. Then, this refrigerant flows, in order, through the heating expansion valve 13, the outside heat exchanger 14, the cooling expansion valve 15, and the air conditioning evaporator 16, and also flows, in order, through the refrigeration expansion valve 22 cooling and the battery evaporator 24.

According to the refrigeration cycle device 10 of the present embodiment, even if the cooling capacity required of the air conditioning evaporator 16 is reduced during the dehumidifying heating mode of the passenger compartment, the cooling capacity of the battery evaporator 24 can be sufficiently provided to sufficiently cool the heat generating devices mounted in the vehicle.

Furthermore, when battery cooling is performed during the dehumidifying heating mode, the refrigeration cycle device 10 of the present embodiment is configured to switch the refrigerant circuit according to the temperature difference between the blowout air temperature TAV and the target blowout temperature TAO.

More specifically, when the temperature difference between the blowout air temperature TAV and the target blowout temperature TAO is equal to or higher than the predetermined determination threshold ΔTh, the refrigeration cycle device 10 of the present embodiment is configured to switch to a refrigeration circuit in which the outside heat exchanger 14 and each of the evaporators 16 and 24 are connected in parallel with respect to the refrigerant flow. This refrigerant circuit is a third refrigerant circuit in which the refrigerant which flowed from the compressor 11 to the water-refrigerant heat exchanger 12 will then flow to the outside heat exchanger 14 through the heating expansion valve 13, flow to the air conditioning evaporator 16 through the cooling expansion valve 15, and flow to the battery evaporator 24 through the refrigeration expansion valve 22.

When the temperature difference between the blowout air temperature TAV and the target blowout temperature TAO is less than the predetermined determination threshold ΔTh, the refrigeration cycle device 10 of the present embodiment is configured to switch to a refrigeration circuit in which the outside heat exchanger 14, the air conditioning evaporator 16, and the battery evaporator 24 are connected in series with respect to the refrigerant flow. In this refrigerant circuit, by adjusting the flow rates of the refrigerant flowing into the outside heat exchanger 14, the air conditioning evaporator 16, and the battery evaporator 24 using the respective expansion valves 13, 15, 22, it is possible for the cooling capacity of the air conditioning evaporator 16 and the cooling capacity of the battery evaporator 24 to be appropriately exhibited.

### Second Embodiment

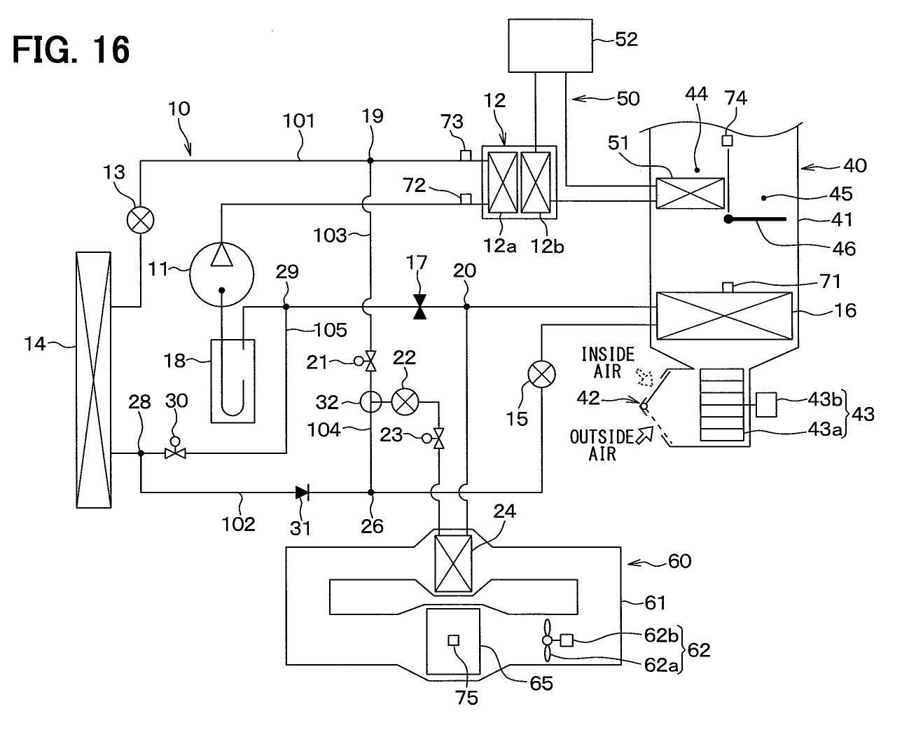

Next, a second embodiment will be described with reference to FIG. 16. As shown in FIG. 16, according to the refrigeration cycle device 10 of the present embodiment, instead of the second passage opening/closing valve 27 that opens and closes the fourth refrigerant passage 104, a three way valve 32 is provided at a connecting portion between the third refrigerant passage 103 and the fourth refrigerant passage 104. The three-way valve 32 is an electric three-way valve whose operation is controlled according to a control signal output from the control device 70.

When battery cooling is performed during the cooling mode, and also when normal battery cooling is performed during the series dehumidifying heating mode, the control device 70 controls the three-way valve 32 such that the refrigerant flowing out from the outside heat exchanger 14 flows into the refrigeration expansion valve 22.

Further, when battery cooling is performed during the heating mode, and also when priority battery cooling is performed during the series dehumidifying heating mode, the control device 70 controls the three-way valve 32 such that the refrigerant flowing out from the water-refrigerant heat exchanger 12 flows into the refrigeration expansion valve 22.

Further, when battery cooling is not performed during the parallel dehumidifying heating mode, the control device 70 controls the three-way valve 32 such that the refrigerant flowing out from the water-refrigerant heat exchanger 12 flows into the cooling expansion valve 15.

In addition, when battery cooling is performed during the parallel dehumidifying heating mode, the control device 70 controls the three-way valve 32 such that the refrigerant flowing out from the water-refrigerant heat exchanger 12 flows into the cooling expansion valve 15 and the refrigeration expansion valve 22.

The remaining configurations are similar to corresponding structures of the first embodiment. The refrigeration cycle device 10 of the present embodiment can obtain the same effects as the refrigeration cycle device 10 of the first embodiment with respect to configurations which are common with the refrigeration cycle device 10 of the first embodiment.

### Third Embodiment

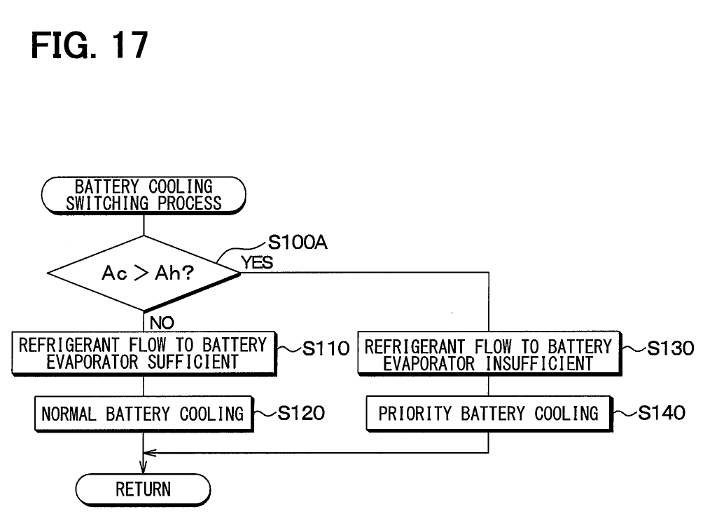

Next, a third embodiment will be described with reference to FIG. 17. In the present embodiment, an example will be described which modifies the switching condition for switching between normal battery cooling and priority battery cooling during the second mode of the series dehumidifying heating mode.

As described with respect to the first embodiment, when normal battery cooling is performed, the refrigerant circuit is such that the flow rate of the refrigerant to the battery evaporator 24 depends on the ratio between the opening surface areas of the cooling expansion valve 15 and the refrigeration expansion valve 22.

Conversely, as described with respect to the first embodiment, when priority battery cooling is performed, the refrigerant circuit is such that the flow rate of the refrigerant to the battery evaporator 24 depends on the ratio between the opening surface areas of the heating expansion valve 13 and the refrigeration expansion valve 22.

In this regard, when battery cooling is performed during the second mode of the series dehumidifying heating mode, the flow rate of the refrigerant to the battery evaporator 24 depends on the ratio between the opening surface area of the refrigeration expansion valve 22 and the smaller one of the opening surface areas of the heating expansion valve 13 and the cooling expansion valve 15.

From the viewpoint of increasing the flow rate of the refrigerant to the battery evaporator 24, it is desirable to branch the flow of refrigerant on the refrigerant flow upstream side of whichever expansion valve among the heating expansion valve 13 and the cooling expansion valve 15 that has the smaller opening surface area.

In this regard, in the present embodiment, during an operation mode in which the outside heat exchanger 14 functions as a heat absorber, if the opening surface area of the cooling expansion valve 15 is greater than the opening surface area of the heating expansion valve 13, the condition that the flow rate of the refrigerant flowing into the battery evaporator 24 is insufficient is assumed to be satisfied.

The switching process between normal battery cooling and priority battery cooling, which is executed by the control device 70 of the present embodiment, will be described with reference to the flowchart of FIG. 17. FIG. 17 is a flowchart showing the flow of a battery cooling switching process executed by the control device 70. Each of the control steps shown in FIG. 17 constitutes a functional unit for implementing various functions and is executed by the control device 70.

When the operation mode of the refrigeration cycle device 10 is determined to be the series dehumidifying heating mode, as shown in FIG. 17, the control device 70 determines in step S100A whether or not an opening surface area Ac of the cooling expansion valve 15 is greater than an opening surface area Ah of the heating expansion valve 13

When this result is that the opening surface area Ac of the cooling expansion valve 15 is determined to be equal to or less than the opening surface area Ah of the heating expansion valve 13, the control device 70 determines in step S110 that the flow rate of the refrigerant flowing into the battery evaporator 24 is sufficient. In other words, when the opening surface area Ac of the cooling expansion valve 15 is determined to be equal to or less than the opening surface area Ah of the heating expansion valve 13, the control device 70 determines that the condition that the flow rate of the refrigerant flowing into the battery evaporator 24 is insufficient is not satisfied. Then, in step S120, the control device 70 determines the battery cooling during the series dehumidifying heating mode to be the normal battery cooling.

Conversely, at step S110, when the opening surface area Ac of the cooling expansion valve 15 is determined to be greater than the opening surface area Ah of the heating expansion valve 13, the control device 70 determines in step S130 that the flow rate of the refrigerant flowing into the battery evaporator 24 is insufficient. In other words, when the opening surface area Ac of the cooling expansion valve 15 is determined to be greater than the opening surface area Ah of the heating expansion valve 13, the control device 70 determines that the condition that the flow rate of the refrigerant flowing into the battery evaporator 24 is insufficient is satisfied. Then, in step S140, the control device 70 determines the battery cooling during the series dehumidifying heating mode to be the priority battery cooling that prioritizes the cooling of the secondary battery 65.

The remaining configurations and operation are the same as those of the first embodiment. The refrigeration cycle device 10 of the present embodiment can obtain the same effects as the refrigeration cycle device 10 of the first embodiment with respect to configurations which are common with the refrigeration cycle device 10 of the first embodiment.

In particular, the refrigeration cycle device 10 of the present embodiment sets the switching condition for switching between normal battery cooling and priority battery cooling during the second mode of the series dehumidifying heating mode as the size relationship between the opening surface area of the cooling expansion valve 15 and the opening surface area of the heating expansion valve 13. Specifically, when the opening surface area of the cooling expansion valve 15 is greater than the opening surface area of the heating expansion valve 13 during the second mode of the series dehumidifying heating mode, the control device 70 of the refrigeration cycle device 10 of the present embodiment is configured to switch to the priority battery cooling refrigerant circuit. For this reason, according to the refrigeration cycle device 10 of the present embodiment, as compared to the refrigeration cycle device 10 of the first embodiment, it is possible to appropriately increase the flow rate of the refrigerant to the battery evaporator 24.

### Comparative Example

A comparative example refrigeration cycle device will be described to illustrate the technical effects and advantages enjoyed by the various aspects of the present disclosure.

Specifically, the refrigeration cycle device of a comparative example includes, on the downstream side of an outside heat exchanger, a first evaporator that cools ventilation air blown into a passenger compartment and a second evaporator that cools air blown to a heat generating device are disposed in parallel with respect to refrigerant flow. Furthermore, in the refrigeration cycle device, using expansion valves disposed in both refrigerant passages leading to each of the evaporators, the flow rate of the refrigerant flowing to each evaporator is adjusted according to the flow rate corresponding to the load of each evaporator. As a result, the refrigeration cycle device is configured for both air conditioning of the passenger compartment and cooling of the heat generating device.

It should be noted that the refrigeration cycle device of the comparative example described above is a refrigerant circuit in which the first evaporator and the second evaporator are connected in parallel with respect to the refrigerant flow on the refrigerant flow downstream side of the outside heat exchanger.

In such a refrigerant circuit, for example when the outside heat exchanger is functioning as a heat absorber, if the cooling capacity required of the first evaporator decreases, the expansion valve provided on the refrigerant flow upstream side of the first evaporator may be controlled to a fully open state.

At this time, if the temperature of the heat generating device is high, a situation may arise in which both of the expansion valves provided on the refrigerant flow upstream side of the respective evaporators are fully opened, and it becomes not possible to sufficiently increase the flow rate of the refrigerant flowing into the second evaporator.

In this regard, contrary to the various aspects of the present disclosure, in the comparative example refrigeration cycle device, when the cooling capacity required of the first evaporator decreases, there is a possibility that the flow rate of the refrigerant flowing into the second evaporator cannot be sufficiently increased, and in this case the cooling capacity of the second evaporator may be insufficient.

### Other Embodiments

Although the representative embodiments of the present disclosure have been described above, the present disclosure should not be limited to the above-described embodiments. For example, various modifications can be made as follows.

In each of the embodiments described above, examples are described in which the refrigeration cycle device 10 is applied to a vehicle air conditioner, but these examples are not limiting. The refrigeration cycle device 10 can be applied to, for example, a stationary type air conditioner.

In each of the embodiments described above, examples are described in which the ventilation air to be blown into the passenger compartment is the heating target fluid and the first cooling target fluid, but these examples are not limiting. The heating target fluid and the first cooling target fluid may be fluids used for different purposes. For example, one of the heating target fluid and the first cooling target fluid may be drinking water or domestic use water, and the other may be air for indoor air conditioning.

In each of the embodiments described above, examples are described in which the refrigeration cycle device 10 cools a secondary battery 65 mounted in a vehicle, but these examples are not limiting. For example, the refrigeration cycle device 10 may be configured to cool a heat generating device such as an inverter, a transmission, etc. mounted in a vehicle.

In the above described embodiments, it is preferable that the refrigeration cycle device 10 is configured to be capable of switching between normal battery cooling and priority battery cooling when battery cooling is performed during the series dehumidifying heating mode, but these examples are not limiting. For example, when battery cooling is performed during the series dehumidifying heating mode, the refrigeration cycle apparatus 10 may be configured to perform priority battery cooling without switching between normal battery cooling and priority battery cooling.

In the above described embodiments, it is preferable that the refrigeration cycle device 10 is configured to be capable of switching between series dehumidifying heating mode and parallel dehumidifying heating mode when dehumidifying and heating the passenger compartment, but these examples are not limiting. For example, the refrigeration cycle device 10 may be configured to perform the series dehumidifying heating mode when dehumidifying and heating the passenger compartment.

In the above embodiments, examples are described in which the radiator of the refrigeration cycle device 10 is constituted by the water-refrigerant heat exchanger 12 for indirectly radiating the refrigerant to the ventilation air via the cooling water, but these examples are not limiting. The radiator of the refrigeration cycle device 10 may be constituted by, for example, a heat exchanger for radiating the refrigerant directly to the ventilation air to be blown into the passenger compartment.

In the first embodiment described above, an example is described in which, when the cooling expansion valve 15 is in the fully open state during an operation mode in which the outside heat exchanger 14 functions as a heat absorber, the condition that the flow rate of the refrigerant flowing into the battery evaporator 24 is insufficient is assumed to be satisfied. However, this example is not limiting.

According to the refrigeration cycle device 10, the situation in which the cooling capacity of the battery evaporator 24 is insufficient may arise during an operation mode in which the outside heat exchanger 14 is functioning as a heat absorber. Therefore, the condition that the flow rate of the refrigerant flowing into the battery evaporator 24 is insufficient may be a condition that is established when, for example, the outside heat exchanger 14 is operating as a heat absorber.

The constituent element(s) of each of the above embodiments is/are not necessarily essential unless it is specifically stated that the constituent element(s) is/are essential in the above embodiment, or unless the constituent element(s) is/are obviously essential in principle.

Furthermore, in each of the above embodiments, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as indispensable or is obviously indispensable in view of the principle of the present disclosure.

Furthermore, in each of the above embodiments, in the case where the shape of the constituent element(s) and/or the positional relationship of the constituent element(s) are specified, the present disclosure is not necessarily limited to the shape of the constituent element(s) and/or the positional relationship of the constituent element(s) unless the embodiment specifically states that the shape of the constituent element(s) and/or the positional relationship of the constituent element(s) is/are necessary or is/are obviously essential in principle.

### CONCLUSION

According to a first aspect corresponding to a portion or all of the above described embodiments, a refrigeration cycle device includes a compressor, a radiator that exchanges heat between the refrigerant discharged from the compressor and a heating target fluid to dissipate heat from the refrigerant, and an outside heat exchanger that exchanges heat between the refrigerant flowing out from the radiator and an outside air. Further, the refrigeration cycle device includes a first evaporator that exchanges heat between the refrigerant and a first cooling target fluid to cause the refrigerant to evaporate, a second evaporator that exchanges heat between the refrigerant and a second cooling target fluid to cause the refrigerant to evaporate, and a first refrigerant passage that guides the refrigerant flowing out from the radiator toward the outside heat exchanger. Further, the refrigeration cycle device includes a first expansion valve in the first refrigerant passage that is capable of decompressing and expanding the refrigerant flowing into the outside heat exchanger, and a second refrigerant passage that guides the refrigerant flowing out from the outside heat exchanger to a refrigerant intake side of the compressor via the first evaporator.

Further, the refrigeration cycle device includes a second expansion valve (15) disposed in the second refrigerant passage between the outside heat exchanger and the first evaporator, a third refrigerant passage that guides the refrigerant flowing between the radiator and the first expansion valve to the second refrigerant passage on the refrigerant flow downstream side of the first evaporator, and a third expansion valve disposed in the third refrigerant passage. Further, the second evaporator is disposed in the third refrigerant passage on the refrigerant flow downstream side of the third expansion valve.

Further, according to a second aspect, the refrigeration cycle device includes a first passage opening/closing valve disposed in the third refrigerant passage on the refrigerant flow upstream side of the third expansion valve, the first passage opening/closing valve being configured to open and close the third refrigerant passage. Further, the refrigeration cycle device includes a fourth refrigerant passage that communicates a portion of the third refrigerant passage between the first passage opening/closing valve and the third expansion valve to a portion of the second refrigerant passage between the outside heat exchanger and the second expansion valve. Further, the refrigeration cycle device includes a second passage opening/closing valve that opens and closes the fourth refrigerant passage, and an opening/closing control unit that controls the first passage opening/closing valve and the second passage opening/closing valve.

Further, the opening/closing control unit is configured to, during an operation mode in which the outside heat exchanger functions as a heat absorber, when a condition that a flow rate of the refrigerant flowing into the second evaporator through the outside heat exchanger is insufficient is satisfied, control each passage opening/closing valve so as to close the fourth refrigerant passage and to open the third refrigerant passage. Further, the opening/closing control unit is configured to, during the operation mode in which the outside heat exchanger functions as the heat absorber, when the condition that the flow rate of the refrigerant flowing into the second evaporator through the outside heat exchanger is insufficient is not satisfied, control each passage opening/closing valve so as to close the third refrigerant passage and to open the fourth refrigerant passage.

According to this, in the refrigeration cycle device, in the case where the flow rate insufficient condition is satisfied for the refrigerant flowing into the second evaporator when the outside heat exchanger is acting as a heat absorber, the refrigerant circuit is such that, with respect to the refrigerant flow, the second evaporator is connected in parallel with the first evaporator and the outside heat exchanger which are connected in series. In this refrigerant circuit, even if the throttle opening degree of the second expansion valve is fully open, the flow rate of the refrigerant flowing into the second evaporator can be increased by reducing the throttle opening degree of the first expansion valve.

Further, when the outside heat exchanger functions as a heat absorber, when the refrigerant flow rate insufficient condition for the second evaporator is not satisfied, the refrigerant circuit is such that, on the refrigerant flow downstream side of the outside heat exchanger, the first evaporator and the second evaporator are connected in parallel. In this refrigerant circuit, by adjusting the flow rates of the refrigerant flowing into the first evaporator and the second evaporator using the second expansion valve and the third expansion valve, it is possible to provide sufficient cooling capacity from the first evaporator and the second evaporator.

In this regard, with a configuration that changes the inflow route of refrigerant flowing into the second evaporator according to whether or not the flow rate insufficient condition of the refrigerant flowing into the second evaporator is satisfied when the outside heat exchanger functions as a heat absorber, it is possible to appropriately exert the cooling capacity in each evaporator.

Further, according to a third aspect, the refrigeration cycle device includes a bypass passage that communicates a portion of the second refrigerant passage on the refrigerant flow upstream side of a connection portion with the fourth refrigerant passage to a portion of the second refrigerant passage on the refrigerant flow downstream side of the first evaporator, and a bypass passage opening/closing valve that opens and closes the bypass passage. Further, the refrigerant cycle device includes a check valve disposed in second refrigerant passage between a connection point to the bypass passage and a connection point to the fourth refrigerant passage, the check valve prohibiting the refrigerant from flowing from the fourth refrigerant passage to the bypass passage via the second refrigerant passage.

In this regard, when each of the first passage opening/closing valve, the second passage opening/closing valve, and the bypass passage opening/closing valve are opened, a refrigerant circuit is formed in which the outside heat exchanger, the first evaporator, and the second evaporator are connected in parallel with respect to the refrigerant flow.

In this refrigerant circuit, by adjusting the flow rates of the refrigerant flowing into the outside heat exchanger, the first evaporator, and the second evaporator using the first to third expansion valves, it is possible to provide appropriate cooling capacity from the first evaporator and the second evaporator.

Further, according to a fourth aspect, a refrigeration cycle device includes a compressor, a radiator dissipates heat of the refrigerant discharged from the compressor, an outside heat exchanger that exchanges heat between the refrigerant flowing out from the radiator and an outside air, and a first evaporator that exchanges heat between the refrigerant and the ventilation air prior to the ventilation air being heated through the radiating, to cause the refrigerant to evaporate. Further, the refrigerant cycle device includes a second evaporator that exchanges heat between the refrigerant and a cooling air to be blown to the heat generating device, to cause the refrigerant to evaporate, a heating expansion valve capable of decompressing and expanding the refrigerant flowing into the outside heat exchanger, and a cooling expansion valve capable of decompressing and expanding the refrigerant flowing into the first evaporator. Further, the refrigerant cycle device includes a refrigeration expansion valve capable of decompressing and expanding the refrigerant flowing into the second evaporator, a circuit switching device that switches a refrigerant circuit through which the refrigerant flows, and a circuit switching control unit that controls the circuit switching device.

The circuit switching device is configured to be able to switch to a first refrigerant circuit in which the refrigerant discharged from the compressor flows through the radiator, the heating expansion valve, and the outside heat exchanger in this order, and then flows, in order, through the cooling expansion valve and the first evaporator in this order, and flows, in order, through the refrigeration expansion valve and the second evaporator in this order. Further, the circuit switching device is configured to be able to switch to a second refrigerant circuit in which the refrigerant which flowed from the compressor to the radiator flows, in order, through the heating expansion valve, the outside heat exchanger, the cooling expansion valve, and the first evaporator, and flows, in order, through the refrigeration expansion valve and the second evaporator in this order.

Further, the circuit switching control unit is configured to, during the dehumidifying heating mode while cooling is performed on the heat generating device, switch from the first refrigerant circuit to the second refrigerant circuit when a condition that a flow rate of refrigerant flowing into the second evaporator is insufficient is satisfied.

Further, according to a fifth aspect, the circuit switching device of the refrigeration cycle device is configured to be able to switch to a third refrigerant circuit for the refrigerant flowing into the radiator. The third refrigerant circuit is a refrigerant circuit in which the refrigerant that flowed into the radiator then flows to the outside heat exchanger through the heating expansion valve, flows to the first evaporator through the cooling expansion valve, and further flows to the second evaporator through the refrigeration expansion valve.

Further, the circuit switching control unit is configured to, during the dehumidifying heating mode while cooling is performed on the heat generating device, switch from the first refrigerant circuit or the second refrigerant circuit to the third refrigerant circuit when a temperature difference between a temperature of the air blown into the passenger compartment and a target blowout temperature is equal to or above a determination threshold.

According to this, when the temperature difference between the temperature of the air blown into the passenger compartment and the target blowout temperature is equal to or higher than the predetermined determination threshold, a refrigerant circuit is formed in which the outside heat exchanger, the first evaporator, and the second evaporator are connected in parallel with respect to the refrigerant flow. In this refrigerant circuit, by adjusting the flow rates of the refrigerant flowing into the outside heat exchanger, the first evaporator, and the second evaporator using the first to third expansion valves, it is possible to provide appropriate cooling capacity from the first evaporator and the second evaporator.

Further, according to a sixth aspect, the refrigeration cycle device includes a first refrigerant passage that guides the refrigerant flowing out from the radiator through the first expansion valve toward the outside heat exchanger, and a second refrigerant passage that guides the refrigerant flowing out from the outside heat exchanger to a refrigerant intake side of the compressor via the second expansion valve and the first evaporator. Further, the refrigeration cycle device includes a third refrigerant passage that guides the refrigerant flowing between the radiator and the first expansion valve to the second refrigerant passage on the refrigerant flow downstream side of the first evaporator via the third expansion valve and the first evaporator.

Further, the refrigeration cycle device includes a fourth refrigerant passage that communicates a portion of the third refrigerant passage on the refrigerant flow upstream side of the third expansion valve to a portion of the second refrigerant passage between the outside heat exchanger and the second expansion valve. Further, the refrigeration cycle device includes a bypass passage that communicates a portion of the second refrigerant passage on the refrigerant flow upstream side of a connection portion with the fourth refrigerant passage to a refrigerant intake side of the first evaporator and the compressor. Further, the refrigeration cycle device includes a check valve disposed in second refrigerant passage between a connection point of the second refrigerant passage to the bypass passage and a connection point of the second refrigerant passage to the fourth refrigerant passage, the check valve prohibiting the refrigerant from flowing from the fourth refrigerant passage to the bypass passage via the second refrigerant passage.

The circuit switching device includes a first passage opening/closing valve disposed in the third refrigerant passage on the refrigerant flow upstream side of a connection portion with the fourth refrigerant passage, the first passage opening/closing valve configured to open and close the third refrigerant passage, a second passage opening/closing valve that opens and closes the fourth refrigerant passage, and a bypass passage opening/closing valve that opens and closes the bypass passage.

The circuit switching control unit is configured to, when switching the refrigerant circuit to the first refrigerant circuit, control the second passage opening/closing valve to be in an open state, and control the first passage opening/closing valve and the bypass passage opening/closing valve to be in a closed state. Further, the circuit switching control unit is configured to, when switching the refrigerant circuit to the second refrigerant circuit, control the first passage opening/closing valve to be in an open state, and control the second passage opening/closing valve and the bypass passage opening/closing valve to be in a closed state. Further, the circuit switching control unit is configured to, when switching the refrigerant circuit to the third refrigerant circuit, control the first passage opening/closing valve, the second passage opening/closing valve, and the bypass passage opening/closing valve to be in an open state.

In this manner, according to a configuration in which the refrigerant circuit through which the refrigerant in the cycle flows can be switched by opening/closing control of each passage opening/closing valve, it is possible to appropriately provide the cooling capacity of the first evaporator and the cooling capacity of the second evaporator.

1. A refrigeration cycle device in which a refrigerant circulates in a cycle, comprising:
a compressor that compresses and discharges a refrigerant;
a radiator that exchanges heat between the refrigerant discharged from the compressor and a heating target fluid to dissipate heat from the refrigerant;
an outside heat exchanger that exchanges heat between the refrigerant flowing out from the radiator and an outside air;
a first evaporator that exchanges heat between the refrigerant and a first cooling target fluid to cause the refrigerant to evaporate;
a second evaporator that exchanges heat between the refrigerant and a second cooling target fluid to cause the refrigerant to evaporate;
a first refrigerant passage that guides the refrigerant flowing out from the radiator toward the outside heat exchanger;
a first expansion valve disposed in the first refrigerant passage that is capable of decompressing and expanding the refrigerant flowing into the outside heat exchanger;
a second refrigerant passage that guides the refrigerant flowing out from the outside heat exchanger to a refrigerant intake side of the compressor via the first evaporator;
a second expansion valve disposed in the second refrigerant passage between the outside heat exchanger and the first evaporator, the second expansion valve being capable of decompressing and expanding the refrigerant flowing into the first evaporator;
a third refrigerant passage that guides the refrigerant flowing between the radiator and the first expansion valve to bypass the first expansion valve and the outside heat exchanger to flow to the second refrigerant passage on the refrigerant flow downstream side of the first evaporator; and
a third expansion valve disposed in the third refrigerant passage that is capable of decompressing and expanding the refrigerant flowing through the third refrigerant passage, wherein
the second evaporator is disposed in the third refrigerant passage on the refrigerant flow downstream side of the third expansion valve.

2. The refrigeration cycle device of claim 1, further comprising:
a first passage opening/closing valve disposed in the third refrigerant passage on the refrigerant flow upstream side of the third expansion valve, the first passage opening/closing valve being configured to open and close the third refrigerant passage;
a fourth refrigerant passage that communicates a portion of the third refrigerant passage between the first passage opening/closing valve and the third expansion valve to a portion of the second refrigerant passage between the outside heat exchanger and the second expansion valve;
a second passage opening/closing valve that opens and closes the fourth refrigerant passage; and
an opening/closing control unit that controls the first passage opening/closing valve and the second passage opening/closing valve, wherein
the opening/closing control unit is configured to
during an operation mode in which the outside heat exchanger functions as a heat absorber, when a condition that a flow rate of the refrigerant flowing into the second evaporator through the outside heat exchanger is insufficient is satisfied, control the first passage opening/closing valve and the second passage opening/closing valve so as to close the fourth refrigerant passage and to open the third refrigerant passage, and
during the operation mode in which the outside heat exchanger functions as the heat absorber, when the condition that the flow rate of the refrigerant flowing into the second evaporator through the outside heat exchanger is insufficient is not satisfied, control the first passage opening/closing valve and the second passage opening/closing valve so as to close the third refrigerant passage and to open the fourth refrigerant passage.

3. The refrigeration cycle device of claim 2, further comprising:
a bypass passage that communicates a portion of the second refrigerant passage on the refrigerant flow upstream side of a connection portion with the fourth refrigerant passage to a portion of the second refrigerant passage on the refrigerant flow downstream side of the first evaporator;
a bypass passage opening/closing valve that opens and closes the bypass passage; and
a check valve disposed in second refrigerant passage between a connection point to the bypass passage and a connection point to the fourth refrigerant passage, the check valve prohibiting the refrigerant from flowing from the fourth refrigerant passage to the bypass passage via the second refrigerant passage.

4. A refrigeration cycle device for use with a vehicle air conditioner capable of adjusting a temperature of ventilation air to be blown into a passenger compartment and capable of cooling a heat generating device mounted in a vehicle, comprising:
a compressor that compresses and discharges a refrigerant;
a radiator that heats the ventilation air by using heat of the refrigerant discharged from the compressor;
an outside heat exchanger that exchanges heat between the refrigerant flowing out from the radiator and an outside air;
a first evaporator that exchanges heat between the refrigerant and the ventilation air prior to the ventilation air being heated through the radiating, to cause the refrigerant to evaporate and to cool the ventilation air;
a second evaporator that exchanges heat between the refrigerant and a cooling air to be blown to the heat generating device, to cause the refrigerant to evaporate and to cool the cooling air;
a heating expansion valve capable of decompressing and expanding the refrigerant flowing into the outside heat exchanger;
a cooling expansion valve capable of decompressing and expanding the refrigerant flowing into the first evaporator;
a refrigeration expansion valve capable of decompressing and expanding the refrigerant flowing into the second evaporator;
a circuit switching device that switches a refrigerant circuit through which the refrigerant flows; and
a circuit switching control unit that controls the circuit switching device, wherein
the circuit switching device is configured to be able to switch between
a first refrigerant circuit in which the refrigerant which flowed from the compressor to the radiator flows through the heating expansion valve and the outside heat exchanger in this order, and then flows, in order, through the cooling expansion valve and the first evaporator in this order, and flows, in order, through the refrigeration expansion valve and the second evaporator in this order, and
a second refrigerant circuit in which the refrigerant which flowed from the compressor to the radiator flows, in order, through the heating expansion valve, the outside heat exchanger, the cooling expansion valve, and the first evaporator, and flows, in order, through the refrigeration expansion valve and the second evaporator in this order, and
the circuit switching control unit is configured to, during a dehumidifying heating mode in which the ventilation air which was cooled at the first evaporator is heated using heat from the refrigerant flowing in the radiator while cooling is performed on the heat generating device, switch from the first refrigerant circuit to the second refrigerant circuit when a condition that a flow rate of refrigerant flowing into the second evaporator is insufficient is satisfied.

5. The refrigeration cycle device of claim 4, wherein
the circuit switching device is configured to be able to switch to a third refrigerant circuit in which the refrigerant which flowed from the compressor to the radiator then flows to the outside heat exchanger through the heating expansion valve, flows to the first evaporator through the cooling expansion valve, and further flows to the second evaporator through the refrigeration expansion valve, and
the circuit switching control unit is configured to, during the dehumidifying heating mode while cooling is performed on the heat generating device, switch from the first refrigerant circuit or the second refrigerant circuit to the third refrigerant circuit when a temperature difference between a temperature of the air blown into the passenger compartment and a target blowout temperature is equal to or above a determination threshold.

6. The refrigeration cycle device of claim 5, further comprising:
a first refrigerant passage that guides the refrigerant flowing out from the radiator through the heating expansion valve toward the outside heat exchanger;
a second refrigerant passage that guides the refrigerant flowing out from the outside heat exchanger to a refrigerant intake side of the compressor via the cooling expansion valve and the first evaporator;
a third refrigerant passage that guides the refrigerant flowing between the radiator and the heating expansion valve to the second refrigerant passage on the refrigerant flow downstream side of the first evaporator via the refrigeration expansion valve and the first evaporator; and
a fourth refrigerant passage that communicates a portion of the third refrigerant passage on the refrigerant flow upstream side of the refrigeration expansion valve to a portion of the second refrigerant passage between the outside heat exchanger and the cooling expansion valve;
a bypass passage that communicates a portion of the second refrigerant passage on the refrigerant flow upstream side of a connection portion with the fourth refrigerant passage to a refrigerant intake side of the first evaporator and the compressor; and
a check valve disposed in second refrigerant passage between a connection point of the second refrigerant passage to the bypass passage and a connection point of the second refrigerant passage to the fourth refrigerant passage, the check valve prohibiting the refrigerant from flowing from the fourth refrigerant passage to the bypass passage via the second refrigerant passage, wherein
the circuit switching device includes
a first passage opening/closing valve disposed in the third refrigerant passage on the refrigerant flow upstream side of a connection portion with the fourth refrigerant passage, the first passage opening/closing valve configured to open and close the third refrigerant passage;
a second passage opening/closing valve that opens and closes the fourth refrigerant passage; and
a bypass passage opening/closing valve that opens and closes the bypass passage, and
the circuit switching control unit is configured to
when switching the refrigerant circuit to the first refrigerant circuit, control the second passage opening/closing valve to be in an open state, and control the first passage opening/closing valve and the bypass passage opening/closing valve to be in a closed state,
when switching the refrigerant circuit to the second refrigerant circuit, control the first passage opening/closing valve to be in an open state, and control the second passage opening/closing valve and the bypass passage opening/closing valve to be in a closed state, and
when switching the refrigerant circuit to the third refrigerant circuit, control the first passage opening/closing valve, the second passage opening/closing valve, and the bypass passage opening/closing valve to be in an open state.

7. A refrigeration cycle device for use with a vehicle air conditioner capable of adjusting a temperature of ventilation air to be blown into a passenger compartment and capable of cooling a heat generating device mounted in a vehicle, comprising:
a compressor that compresses and discharges a refrigerant;
a radiator that heats the ventilation air by using heat of the refrigerant discharged from the compressor;
an outside heat exchanger that exchanges heat between the refrigerant flowing out from the radiator and an outside air;
a first evaporator that exchanges heat between the refrigerant and the ventilation air prior to the ventilation air being heated through the radiating, to cause the refrigerant to evaporate and to cool the ventilation air;
a second evaporator that exchanges heat between the refrigerant and a cooling air to be blown to the heat generating device, to cause the refrigerant to evaporate and to cool the cooling air;
a heating expansion valve capable of decompressing and expanding the refrigerant flowing into the outside heat exchanger;
a cooling expansion valve capable of decompressing and expanding the refrigerant flowing into the first evaporator;
a refrigeration expansion valve capable of decompressing and expanding the refrigerant flowing into the second evaporator;
a circuit switching device including a plurality of electronically controlled valves that switches a refrigerant circuit through which the refrigerant flows; and
a circuit switching control unit that controls the circuit switching device, wherein
the circuit switching device is configured to be able to switch between
a first refrigerant circuit in which the refrigerant which flowed from the compressor to the radiator flows through the heating expansion valve and the outside heat exchanger in this order, and then flows, in order, through the cooling expansion valve and the first evaporator in this order, and flows, in order, through the refrigeration expansion valve and the second evaporator in this order, and
a second refrigerant circuit in which the refrigerant which flowed from the compressor to the radiator flows, in order, through the heating expansion valve, the outside heat exchanger, the cooling expansion valve, and the first evaporator, and flows, in order, through the refrigeration expansion valve and the second evaporator in this order, and
the circuit switching control unit includes a processor coupled to the circuit switching device and is programmed to, during a dehumidifying heating mode in which the ventilation air which was cooled at the first evaporator is heated using heat from the refrigerant flowing in the radiator while cooling is performed on the heat generating device, switch from the first refrigerant circuit to the second refrigerant circuit when a condition that a flow rate of refrigerant flowing into the second evaporator is insufficient is satisfied.
